(19) United States
(12) Patent Application Publication
(10) Pub. No.: US 2007/0207254 A1
(43) Pub. Date: Sep. 6, 2007

(54) METHODS OF SEPARATING FAT FROM SOY MATERIALS AND COMPOSITIONS PRODUCED THEREFROM

(75) Inventor: Donald L. Crank, Alexandria, MN (US)

Correspondence Address: MICHAEL BEST & FRIEDRICH, LLP, ONE SOUTH PINCKNEY STREET, P O BOX 1806, MADISON, WI, 53701, US

(73) Assignee: SPECIALTY PROTEIN PRODUCERS, INC., Port Washington, WI (US)

(21) Appl. No.: 11/681,215

(22) Filed: Mar. 2, 2007

Related U.S. Application Data
(60) Provisional application No. 60/778,802, filed on Mar. 3, 2006.

(51) Int. Cl. A23L 1/20

(52) U.S. Cl. 426/634

(57) ABSTRACT

Disclosed are methods for separating a fat-enriched fraction and a reduced-fat extract from soy materials. Also disclosed are a fat-enriched fraction, a crude oil, a degummed oil, soy gums, a reduced-fat soy extract, reduced-fat soy protein compositions and food products comprising the reduced-fat extracts or reduced-fat protein compositions.

### CROSS-REFERENCE TO RELATED APPLICATIONS

This application claims the benefit of U.S. Provisional Patent Application No. 60/778,802 filed Mar. 3, 2006, which is incorporated by reference herein.

### STATEMENT REGARDING FEDERALLY SPONSORED RESEARCH

None.

### INTRODUCTION

Soybeans are an important food crop used in a wide variety of food products. Recently, consumer demand for low- or reduced-fat, high protein soy products has increased dramatically. In addition, there is growing consumer demand for natural, organic and environmentally friendly or “green” food products. Several methods are currently used commercially to produce reduced fat soy protein for use in food products, including solvent extraction and press-based methods, e.g., extruder, expeller, continuous and cold press methods. These methods produce an oil fraction and a defatted flake or cake.

In solvent extraction, a solvent, generally hexane, is used to produce an oil and flake, which contains residual solvent. These solvents are not considered natural and cannot be used to produce certified organic food products under United States Department of Agriculture (USDA) guidelines for organic food labeling.

The extruder press method is used commercially to produce organic soy protein products and organic soy-derived oils. However, oil recovery by the extruder press method is relatively inefficient, and a fairly high percentage of fat remains in the cake. Furthermore, commercially available partially defatted cakes and flour produced by the extruder press method are characterized by poor protein solubility and reduced protein functionality.

There exists a need in the art for a method to separate soy fat from soy protein to produce low-fat, protein-rich compositions and oils that can be certified organic.

### SUMMARY

In one aspect, the present invention provides a method of processing a soy material. A soy material is aqueously extracted to produce an extract, which is centrifugally separated into a fat-enriched fraction and a reduced-fat extract. The aqueous extraction may comprise addition of an aqueous solution comprising water to the soy material. The aqueous solution may have an ionic strength of about 0.10 N or less and may be substantially free of demulsifiers. The fat-enriched fraction may optionally be further processed to produce an oil. The reduced-fat extract may optionally be further processed to produce an evaporated or spray dried product.

Alternatively, the reduced-fat extract may be further processed and concentrated to produce a reduced-fat soy protein composition. The reduced-fat extract may optionally be contacted with an acid in an amount effective to produce a first curd and whey. The curd may be separated from the whey to produce a first reduced-fat soy protein composition. The first reduced-fat soy protein composition may be washed to produce a second reduced-fat soy protein composition.

Alternatively, the reduced-fat extract may be concentrated by filtration to produce a first reduced-fat soy protein composition. The resulting first reduced-fat soy protein composition may be subjected to a further round of filtration to obtain a second reduced-fat soy protein composition.

Also provided are a reduced-fat soy extract, a fat-enriched fraction, a reduced-fat soy protein composition having at least 65% dry weight protein, a reduced-fat soy protein composition having at least 85% dry weight protein, a glycinin-enriched fraction, a beta-conglycinin-enriched fraction, a crude oil, a degummed oil, a soy oil, soy gums and a protein-fat sediment produced according to the methods of the invention.

In another aspect, a soy protein composition comprising at least about 65% dry weight protein is provided. The soy protein composition is prepared from a non-hexane, non-alcohol treated soy material and having a Protein Dispersibility Index (PDI) of at least about 60%. Food products containing the soy protein compositions are also provided.

In a further aspect, a food product prepared from a soy protein composition comprising at least about 65% dry weight protein is provided. The soy protein composition is produced from a non-hexane, non-alcohol extracted soy material.

In a still further aspect, a soy extract comprising at least about 55% dry weight protein is provided. The soy extract is produced by non-hexane, non-alcohol extraction of a soy material. The soy material has a PDI of at least about 60%. Also provided are food products containing the soy extract.

### BRIEF DESCRIPTION OF THE DRAWINGS

FIG. 1 is a schematic flow diagram showing a method of fractionating soy material to produce soy-based milk. Dashed lines represent alternative or optional steps in the process.

FIG. 2 is a schematic flow diagram showing a method of fractionating soy material to produce a reduced-fat soy protein and a fat fraction using acid precipitation. Dashed lines represent alternative or optional steps in the process.

FIG. 3 is a schematic flow diagram showing a method of fractionating soy material to produce a reduced-fat soy protein and a fat fraction using filtration. Dashed lines represent alternative or optional steps in the process.

FIG. 4 is a schematic flow diagram showing a method of processing the fat-enriched fraction to produce soy oils and gums. Dashed lines represent alternative or optional steps in the process.

### DETAILED DESCRIPTION OF THE INVENTION

The present invention provides methods for fractionating soy material by aqueously extracting soy material and centrifugally separating the aqueous extract to form a fat-enriched fraction (or “cream”) and a reduced-fat soy extract having an increased protein to fat ratio, relative to that of the starting soy material. These materials can be further processed to obtain a variety of products having desirable characteristics.

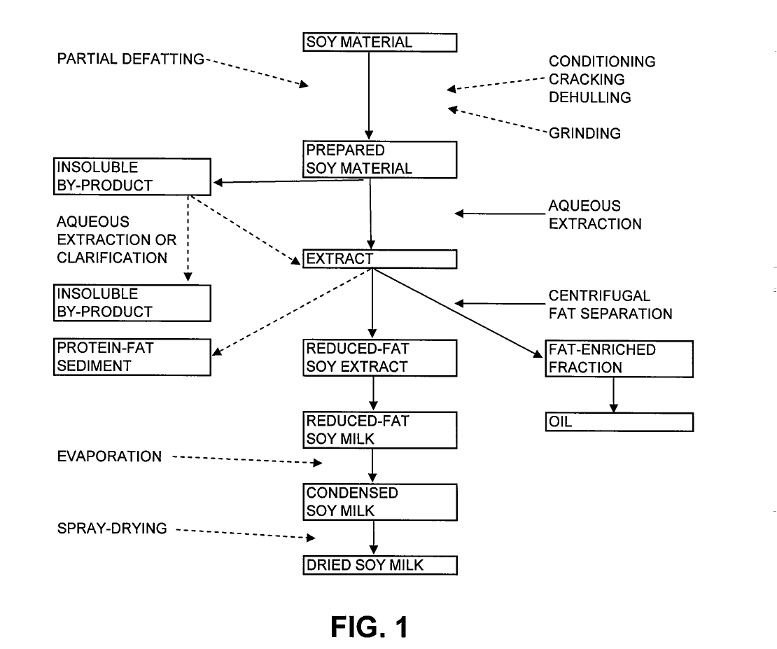

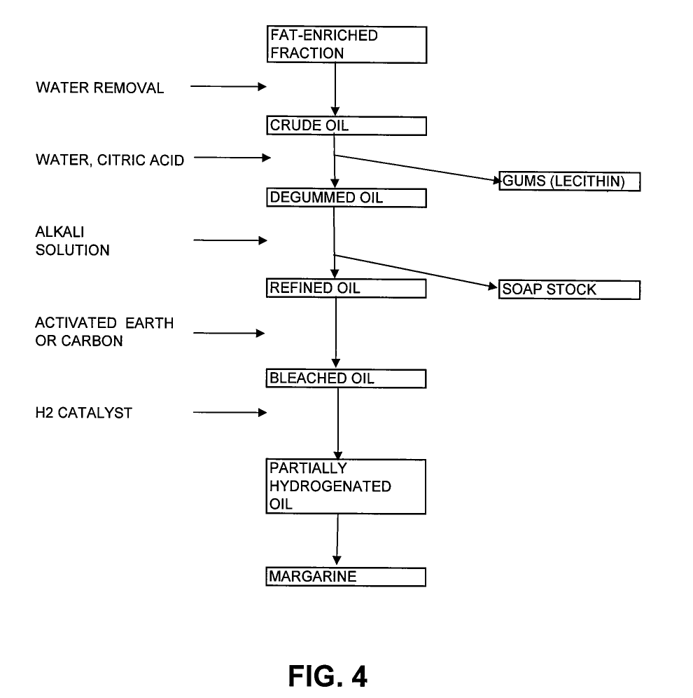

The reduced-fat extract prepared according to the present invention may be used to produce a low fat soy milk having at least 50% protein and 15% or less fat, or it may be further processed to make reduced fat soy protein compositions, including reduced fat soy protein compositions containing at least 65% dry basis protein (soy protein concentrate; 2006 definition of the American Association of Feed Control Officials), and reduced fat soy protein compositions containing at least 90% dry basis protein (soy protein isolate). The fat-enriched fraction can be used to produce oils and gums, including soy lecithin. Additionally, in certain embodiments, a protein-fat sediment comprising fiber and enriched in phospholipids may be obtained. FIG. 1-4 diagram how soybean material may be processed to obtain various compositions useful in the manufacture of a variety of food products and nutraceuticals according to the invention.

Aqueously extracted soy is centrifugally separated based on the differential densities of the materials to form a relatively high density reduced-fat fraction (a reduced-fat soy extract) and a relatively low density fat-enriched fraction.

Any suitable soy material may be used in the method of the invention, provided that aqueous extraction of the soy material yields an aqueous extract comprising fat capable of being removed by centrifugation. The soy materials include but are not limited to, traditional crop grown soybeans, non-GMO (genetically-modified organism) soybeans, GMO soybeans, and organically grown soybeans. Suitable soy materials include a substantially full fat soy material, i.e. a soy material that has not been defatted prior to milling. Alternatively, the soy material can be partially defatted by any suitable method. Methods of obtaining a partially defatted soy material are known in the art and include, but are not limited to screw press, extruder press, cold press, high pressure liquid extraction using e.g., carbon dioxide, nitrogen, or propane, and supercritical fluid fat extraction. The partially defatted cakes thus produced are optionally milled into partially defatted flour prior to aqueous extraction and centrifugal fat separation. In the Examples, flour and cakes that were partially defatted using either an extruder press process or high pressure liquid extraction (HPLE) process using carbon dioxide prior to centrifugal fat separation were used. Commercially available flour, flakes, cakes, grits and meals may also be used in the centrifugal fat separation methods.

The soy material used in the methods can be prepared for processing by any suitable means, including but not limited to, drying, conditioning to achieve an equilibrated moisture level, dehulling, cracking, and cleaning to remove trash, weeds, hulls or other undesirable material from the soy material by counter current air aspiration, screening methods or other methods known in the art. The soy materials are optionally further processed by milling using any suitable means including, but not limited to, using a hammer mill, a roller mill or a screw-type mill. The resulting flour can have a variety of particle sizes. Suitably 40 to 1000 mesh flour is used for extraction, more suitably 100 to 600 mesh flour is used, but any suitable flour, flake, grit, meal or cake may be used.

Substantially full fat soy materials may contain greater than about 10% fat content by weight. Suitably the fat content of a substantially full fat soy material is greater than about 15%, 20% or even 25% by weight. A partially defatted soy material includes any soy material from which at least a portion of the fat has been removed. The fat content of a partially defatted soy material may be greater than about 3%, 5%, 10% or 15% fat by weight.

The full-fat or partially defatted soy material is extracted with an aqueous solution. As used herein, the term “aqueous solution” includes water substantially free of solutes (e.g. tap water, distilled water or deionized water) and water comprising solutes. As one of skill in the art will appreciate, the aqueous solution may contain additives such as salts, buffers, acids and bases. Because fat separation can be effected by the methods of the invention without the addition of demulsifiers, suitably the aqueous solution is substantially free of demulsifiers. Aqueous solutions substantially free of demulsifiers include those containing about 0.01% or less demulsifier by weight. Suitably the aqueous solution contains about 0.005% or less, or more suitably about 0.001% or less demulsifier by weight. Suitably, the aqueous solution has an ionic strength about 0.10 N or less, more suitably about 0.07 N, 0.05 N or 0.02 N or less. The extraction temperature may be between about 32° F. and about 200° F., suitably from about 32° F. to about 150° F., more suitably between about 80° F. and about 150° F., more suitably between about 90° F. and about 145° F. and even more suitably between about 110° F. and 140° F. Products having different functional characteristics may be obtained by including additives or varying the extraction temperature.

In the Examples below, water is added to the flour in a ratio of about 4 to about 16 parts by weight to each part of soy material. However, more or less water may be used. In the Examples, the pH was adjusted by adding calcium hydroxide, to facilitate extraction of the proteins. Other bases may be added to adjust the pH including, but not limited to, sodium hydroxide, ammonium hydroxide, and potassium hydroxide. Suitably the pH is adjusted to between about 6.0 and about 10.5, even more suitably the pH is adjusted to between about 7.0 and about 9.0 to optimize extraction. Suitably the pH is greater than about 7.0 and more suitably the pH is about 7.5. The extraction may be conducted with or without agitation for a period of time effective to extract protein. Suitably the extraction is conducted for at least 10 minutes, and more suitably extraction is conducted for at least 30 minutes, 1 hour, 2 hours, or 4 hours. As one of skill in the art will appreciate, shorter or longer extraction periods may be used.

The extract may be separated from at least a portion of the insoluble by-product (e.g., insoluble fiber fraction or okara) prior to fat removal by centrifugation. This may be accomplished using horizontal decanters, disk-type desludgers, disk-type clarifiers, or similar machines to separate liquids and solids. In the Examples, a disk-type clarifying centrifuge or a horizontal decanter was utilized to remove the insoluble fiber fraction prior to centrifugal fat separation. The insoluble fiber fraction may be used for animal feed, or further processed and dried for use as an animal or human food ingredient.

Optionally, to increase recovery of protein, the insoluble fiber fraction can be washed by adding aqueous solution to the insoluble by-product and centrifuging as above. A disk-type clarifying centrifuge may optionally be used to remove residual insoluble fiber fraction. The resulting extract can then be subjected to centrifugal fat separation as detailed below.

In general, relatively large, low density fat globules can be separated from the aqueous extract by centrifugal fat separation more completely than smaller, higher density fat globules. Fat globule size may be affected by the preparation of the soy material and by the extraction conditions. Centrifugal fat separation may be improved by preparing the extract in a way that maintains the density differential between the fat globules and the water in the aqueous extract. Centrifugal separation of fat may be enhanced by minimizing mechanical treatments, minimizing storage and exposure to heat of soy materials prior to fat separation, processing raw materials as whole, undamaged beans close to time of use, minimizing exposure to air after removal of the hull, reducing microbial growth in the aqueous extract, reducing foam generation in aqueous extract, reducing air entrainment in the aqueous extract, selecting processing conditions and heat treatments that do not increase the free fatty acid content of the aqueous extract, eliminating treatments that promote emulsification, maintaining the pH of the extract above about 6.0. Suitably more than about 40%, 50%, 60%, 70%, 80%, or 90% or more of the fat is capable of being removed from the aqueous extract following centrifugal separation.

Centrifugal separation of the aqueous extract may be accomplished by any suitable method and can be performed as a batch, semi-continuous or continuous process. Briefly, the aqueous soy extract may be delivered to a continuous disk-type separator operated under conditions to allow separation of at least a portion of the fat from the remaining extract. The separator may be configured either with a solid bowl or with a continuous or intermittent solids discharge design. The disk angles and the disk spacing may be altered as well. In one embodiment, a continuous discharge, disk-type, two-phase solid bowl separator, such as model MP-1254 from Westfalia Separator Industries (Oelde, Germany) is used. Alternatively, a three-phase separator, such as model MRPX-418 HGV from Westfalia Separator Industries (Oelde, Germany), may be used. Use of a three phase separator allows simultaneous separation of insoluble by-products (e.g., insoluble fiber fraction or okara) from the reduced-fat soy extract and the fat-enriched fraction.

In another embodiment, at least a portion of the insoluble fiber (e.g., okara) is removed from the aqueous extract by centrifugation prior to centrifugal separation of the fat-enriched fraction from the reduced-fat extract as described above. Preferably, some fiber remains in the aqueous extract. A three phase separator may then be used to form a reduced-fat extract, a fat-enriched fraction, and a sediment containing protein, fat, and fiber (protein-fat sediment). As shown in Example 5, this protein-fat sediment has a unique composition consisting of about 50% protein, about 30% fat and about 10% fiber. The relative percentages may vary depending on the composition of the starting materials and the conditions used for extraction and centrifugal separation. The protein-fat sediment is enriched in phospholipids, and may be useful in production of food products or nutraceuticals.

The percentage of fat removed from the soy extract can be varied by altering the specific parameters used for centrifugal separation consistent with Stokes law. The efficiency of fat removal can be affected by altering the feed rate of the extract into the separator (time) or the g-force applied by the separator (angular velocity). Centrifugal fat separation may result in about a 2 fold increase in the protein to fat ratio of the reduced-fat extract as compared to the extract prior to centrifugal fat separation. Suitably, the protein to fat ratio increase is about 3 fold, 4 fold or more. The centrifugal fat separation process may remove at least about 40% of the fat content of the extract by weight. Suitably the centrifugal fat separation process may remove about 60%, 70% or even more of the fat by weight from the extract. The reduced-fat extract produced by the methods suitably has a 4 to 1 protein to fat ratio. The protein to fat ratio is more suitably about 5 to 1, 6 to 1, 8 to 1, 10 to 1 or even 12:1.

The relative amount of fat removed from the extract can also be affected by altering the preparation of the extract. For example the milling process, extraction and handling of the soy material may affect the amount of fat removed by centrifugal fat separation. One of skill in the art will appreciate that the efficiency of fat separation can be altered by changing the preparation methods in a variety of ways including but not limited to altering the density of the soy extract, the extraction temperature or the size of fat globules in the extract. While any temperature may be used for centrifugal fat separation, a temperature between about 120° F. and about 180° F. is suitable. More suitably, a temperature between about 120° F. and about 150° F. is utilized.

The fat-enriched fraction (or cream) and the reduced-fat extract (reduced-fat soy milk) can be further processed to produce reduced-fat soy protein products and soy-derived oils. The fat-enriched fraction may be cooled and stored in refrigerated tanks for use as a food ingredient in other applications or further processed to remove at least a portion of the water to produce soy-derived oils and gums using methods known in the art. (See Erickson, et al. 1980. Handbook of Soy Oil Processing and Utilization, American Soybean Association and the American Oil Chemists Society, St. Louis, Mo. and Champaign, Ill. incorporated herein by reference in its entirety.) The reduced-fat extract may be used as reduced-fat soy milk or may be further processed to produce protein concentrate or protein isolate using methods known in the art. (See Zerki Berk, 1992. Technology of Production of Edible Flours and Protein Products from Soybeans, Food and Agriculture Organization of the United Nations Agriculture Services Bulletin No. 97, Haifa, Israel, incorporated herein by reference in its entirety.)

After centrifugal fat separation, the resulting reduced-fat soy extract can be used to produce a low fat or nonfat soy milk product as diagrammed in FIG. 1. The reduced-fat soy milk may be consumed as a liquid (e.g., soymilk) or may be used to manufacture numerous food products. For example, the solids concentration or pH may be adjusted, additives can be included, or reduced-fat extract may be subjected to further processing to create specific reduced-fat soy extract products. Food products include, but are not limited to, soy milk beverages, yogurt, or other products with functional properties advantageous for a specific food product application as discussed below. Optionally, a portion of the fat-enriched fraction can be added to the reduced-fat extract to produce soy extracts having a precise protein to fat ratio. For example, the reduced-fat soy extract could have fat added to produce a low-fat, rather than a nonfat product. Alternatively, the reduced-fat soy extract may be condensed in an evaporator, or may be spray dried to produce a reduced-fat soy extract powder. The reduced-fat soy extract powder may also be used in a variety of food products as would be understood by one of skill in the art.

The soy milk product is designated as either low fat or nonfat depending on the ratio of protein to fat in the soy milk. Currently no nonfat soymilk products that are organically certifiable are available commercially. As demonstrated in Examples 1 and 2, the method disclosed herein produces soy protein compositions that may be used to make a nonfat organically certifiable soymilk. See Example 9. Low fat soy milk can be produced by removing enough fat from the soy extract, or alternatively adding fat back to the reduced-fat soy extract, so that the protein to fat ratio is at least 4 to 1 (w/w), or about 1.55 g of fat or less per 8 ounce serving, assuming that a soy-based milk product typically contains at least 6.25 g of protein per serving. These reduced-fat soy milk products contain at least about 55% protein on a dry solids basis and about 15% or less dry weight acid hydrolyzed fat. Suitably reduced-fat soy milk products contain at most about 10% dry weight acid hydrolyzed fat, or more suitably about 7% or less dry weight acid hydrolyzed fat and at least about 60% dry weight protein. More suitably the protein to fat ratio of reduced-fat soy milk is about 5 to 1 (w/w) or more suitably about 8 to 1 (w/w) or higher. As described above, the amount of fat removed by centrifugal fat separation can be altered by adjusting the parameters of the fat separation method to produce fat free or nonfat soy milk by centrifugally removing additional fat so that one 8 ounce serving of the milk contains 0.5 g of fat or less. The ratio of protein to fat in fat free milk is at least about 12 to 1 (w/w).

The reduced-fat extract can be fractionated by methods known to those of skill in the art to produce soy protein fractions. Briefly, any kind of water-soluble salts and sulfurous ions, including but not limited to, sodium bisulfite, sodium sulfite, sodium carbonate, magnesium chloride, and calcium chloride can be added to the reduced-fat extract. The pH of the reduced-fat extract is then adjusted to a specific pH level (usually between pH 5.0 to pH 7.0) with an acid. The reduced pH causes the 11S protein fraction to precipitate and allows production of an 11S enriched precipitate and a liquid extract. The liquid extract can then undergo a further pH adjustment to between about pH 4.0 and about pH 5.0 (for example) to concentrate and precipitate a 7S enriched soy protein fraction. Other fractionation steps can be used to allow further fractionation of the remaining liquid extract (e.g., to separate the 2S and 15S fractions) using more narrow pH ranges. Example 6 provides an additional method for fractionating the reduced-fat soy extract into a conglycin-enriched fraction and a beta-conglycinin-enriched fraction.

Alternatively, other methods known in the art may be used to produce a variety of soy protein fractions. For example, the 2S, 7S, 11S and 15S proteins are the most commonly reported soy protein fractions. Soybeans as a Food Source (CRC Press, Cleveland, Ohio, 1971) reports the 2S protein fraction (8,000-21,500 M.W.) typically comprises approximately 22% of the total weight of the protein, the 7S (110,000-210,000 M.W.) approximately 37% of the total weight of the protein, the 11S (about 350,000 M.W.) about 31% of the total weight of the protein and the 15S (about 600,000 M.W.) approximately 11% of the total weight of the protein composition of defatted soybean products. These protein fractions may be precipitated from solution at an isoelectric pH within the range of pH 4.0-5.0. Davidson et al. discloses a multiple-staged soy isolate separation recovery process (U.S. Pat. No. 4,172,828). Shemer discloses extracting the water-soluble protein and carbohydrate constituents at a pH 5.1-5.9 in the presence of an antioxidant followed by a pH 4.5 adjustment with phosphoric acid to provide a viscous proteinaceous solution containing more than 70% by weight 7S soy protein fraction (U.S. Pat. No. 4,188,399). John R. Turner discloses the use of an alkaline material such as sodium sulfite, sodium carbonate or sodium hydroxide to extract glycinin at a pH 6.4-6.8 (U.S. Pat. No. 2,489,208). The glycinin is then precipitated from the extract by adjusting the extract to its isoelectric pH (e.g. pH 4.2-4.6) such as with sulfur dioxide. Howard discloses isolating 3 different soy protein fractions by extracting the water-soluble protein and carbohydrate at a pH 8.0 in the presence of sodium chloride and sodium bisulfite followed by a adjustment to pH 6.0 with acid to provide an 11S precipitate fraction (U.S. Pat. No. 4,368,151). The fractionated proteins have various uses as will be appreciated by those of skill in the art.

A reduced-fat extract may optionally be further processed to make reduced-fat soy protein compositions by concentration and separation methods known in the art, such as acid precipitation of the proteins and filtration, including e.g. ultrafiltration, microfiltration or diafiltration. These methods can be used to produce soy protein compositions that are organic certifiable. The protein compositions produced may be a concentrate, containing at least 65% protein on a dry weight basis, or an isolate, containing at least 90% protein on a dry weight basis, depending on the specific process used and the starting materials. Suitably the final protein compositions contain at least about 65%, 75%, 85% or 90% protein on a dry weight basis. The final protein products may comprise a protein to fat ratio of at least about 5 to 1 (w/w) and optionally a protein to fat ratio of about 8 to 1, about 10 to 1 or even about 12 to 1 (w/w) or higher. The reduced-fat soy protein compositions may contain about 15% or less dry weight fat and suitably contain about 10% or even about 7% or less dry weight fat.

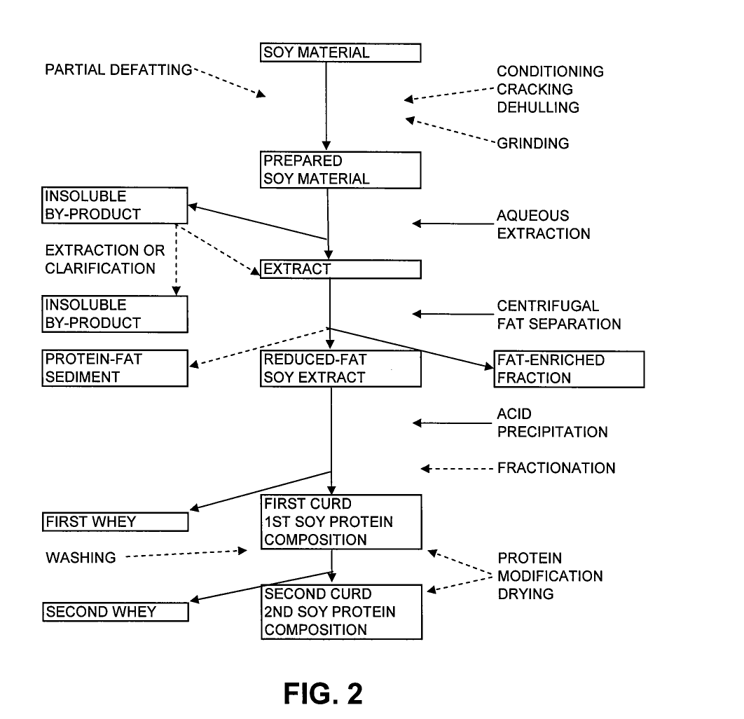

In Examples 1-3, proteins in a reduced-fat extract were concentrated by acid precipitation and separated by centrifugation, as diagrammed in FIG. 2, to produce a soy protein concentrate or isolate from partially defatted or from full fat soy material. Briefly, proteins in the reduced-fat extract can be precipitated by adding acid, such as citric acid, to the isoelectric point of the protein. The precipitated protein (“first curd”) can be separated from the first whey in a continuous horizontal decanter, disk-type clarifier, or disk-type desludger, such as the disk-type clarifying centrifuge model SB-7 available from Westfalia Separator Industries (Oelde, Germany) used in the Examples below. The separated first curd constitutes the first reduced-fat soy protein composition. The first soy protein compositions produced in the Examples were washed by adding an aqueous solution to the first soy protein composition and centrifuging to produce second soy protein compositions with higher concentrations of protein. In each of the Examples, soy isolate containing at least 90% protein was produced.

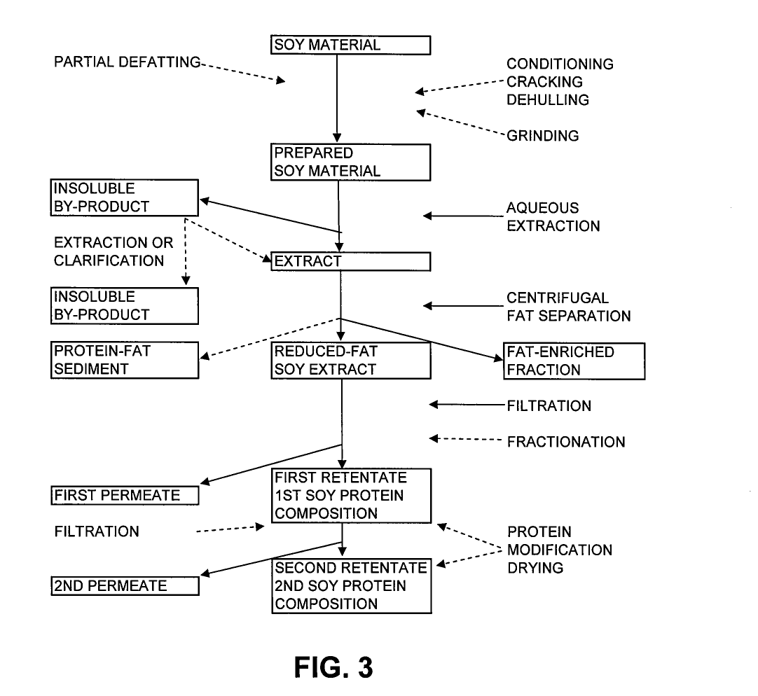

In Example 4, the reduced-fat extract was concentrated and separated by ultrafiltration as diagrammed in FIG. 3 to produce a soy concentrate from full fat soy material. This process may also be used to produce a soy protein composition from partially defatted soy materials prepared by any means known in the art including, but not limited to, hot pressed, cold pressed, high pressure liquid extracted or supercritical fluid extracted soy materials. This process includes passing the reduced-fat extract through a microporous ultrafiltration membrane system to produce a protein-rich retentate. The protein-rich retentate from ultrafiltration (first reduced-fat soy protein composition) may be modified and dried to a powder to produce a protein concentrate, or further processed in a second stage diafiltration or ultrafiltration process. The second retentate constitutes the second reduced-fat soy protein composition. In addition to ultrafiltration, one of skill in the art will appreciate that any suitable method for concentrating and separating the protein from the aqueous solution could be used to obtain a protein concentrate or isolate.

The soy protein compositions described herein may be used by persons skilled in the art to make numerous products. For example, the solids concentration and pH may be adjusted or the reaction conditions altered to produce protein products with different functional characteristics. In addition, various additives may be included or procedures performed using the concentrates and isolates to create specific products with functional properties advantageous for a particular application. For example, a portion of the fat-enriched fraction can be added to the soy protein composition to adjust the protein to fat ratio. The soy concentrates and isolates prepared by the methods may be used to manufacture many different types of products. The resulting soy protein isolate or concentrate can be dried to a free flowing powder in a spray drier, flash drier, or other similar food grade drying system known to those of skill in the art.

The products produced by this method have increased functionality as compared to organic certifiable soy protein products currently available (e.g., those produced from extruder press soy materials) in part because soy materials having a high Protein Dispersibility Index (PDI) can be used as starting materials. Improved functionality is partly due to reduced exposure to heat during processing of the soy materials. Decreased PDI is one suitable measure of reduced functionality. Additionally, the resulting products do not contain the undesirable contaminants associated with hexane or alcohol extracted soy materials. In one embodiment, soy concentrates and isolates are produced from full fat soy material having a PDI of at least about 65%. Suitably the full fat soy material is not extracted with hexane or alcohol and has a PDI of at least about 70%; even more suitably the soy material has a PDI of at least about 80%. The protein dispersibility indices are measured to determine the relative extractability of the starting soy material and are indicative of the solubility of the resulting soy protein compositions. A low PDI, on a scale of 0-100%, indicates low protein extractability and a high PDI indicates a high level of protein extractability. The PDI method is the recommended practice of the AOCS, 5th Edition, Method Ba 10-65. In the method, the sample is placed in suspension and blended at 8500 rpm for 10 minutes. A portion of sample slurry is centrifuged and an aliquot of the supernatant is analyzed for Kjeldahl protein. The supernatant protein value is divided by the sample protein value and multiplied by 100 to give the percent Protein Dispersibility Index (PDI).

The products of the invention have some functional properties considered to be desirable in soy material protein concentrates and isolates. The following functional properties of reduced-fat soy proteins made according to the present invention have been evaluated or are currently being evaluated: surface hydrophobicity, water binding ability, fat binding, emulsification, gel hardness and deformability, solution particle size, solubility, dispersibility, whippability, viscosity, color and taste as well as others.

The surface hydrophobicity of the soy protein compositions is an important functional characteristic for use of the protein compositions in food products. Surface hydrophobicity may be determined by a fluorescence probe method (as described in “Hydrophobicity determined by a florescence probe method and its correlation with surface properties of proteins”, A. Kato, S. Nakai, Biochimia et Biophysica Acta.; Vol 624, No. 13-20, (1980)) which is incorporated herein by reference in its entirety. According to this method, proteins are adsorbed to the interface between oil and water due to their amphiphilic nature, causing a pronounced reduction of the interfacial tension that readily facilitates emulsification. More hydrophobic proteins, which lower the interfacial tension to a greater extent, show superior binding of lipophilic materials including cis-parinaric acid. When bound to proteins, the cis-parinaric acid fluoresces and provides a measurement of protein surface hydrophobicity. A strong correlation exists between the protein surface hydrophobicity determined fluorimetrically with the interfacial tension and emulsifying activity of the proteins. In particular, the fluorescence slope method can be directly correlated to the functional properties of a protein composition and its usefulness in emulsion systems.

As shown in Example 7, the surface hydrophobicity of protein compositions prepared from full fat soy materials using the centrifugal fat separation was found to be significantly higher than that of protein compositions prepared by other processes. The soy protein compositions prepared from full fat soy materials had a surface hydrophobicity producing a slope of fluorescence intensity vs. protein concentration of greater than about 100, suitably greater than about 110. The observed surface hydrophobicity was at least 15%, and suitably at least about 20% higher than that observed for hexane extracted or hot pressed soy materials.

Protein:water gel strength is a measure of the strength of a refrigerated gel made using a soy protein composition. The strength of the gel is measured using a TX-TI texture analyzer which drives a cylindrical probe into the gel until the gel is ruptured by the probe and calculating the gel strength in newtons from the recorded break point of the gel in grams.

As reported in Example 11, all of the products produced using the fat separation process as described herein, have higher gel strength than the other commercial organic soy protein products tested, regardless of raw material used. In particular the gel strength of the full fat soy material and the HPLE prepared soy material were much greater than that of the commercially available products. The gel strength of the composition is at least about 20% higher than that of a soy protein composition that was defatted by a hot press method. The protein compositions suitably have gel strengths of greater than about 2.2 newtons, suitably greater than about 2.3 newtons and more suitably greater than about 2.4 newtons as measured by the method of Example 11. Thus, the soy protein compositions of the present invention are suitable for use as high gel food ingredients in many kinds of food products such as meat emulsions, meat analogs, yogurt, imitation cheese, and other products where the ability to form a protein gel in water is desired.

Protein:oil:water emulsion strength is a measure of the strength of a refrigerated oil and water emulsion with soy protein. The strength of the emulsion is measured using a TX-TI texture analyzer which drives a cylindrical probe into the emulsion until the emulsion is ruptured by the probe and calculating the emulsion strength from the recorded break point of the emulsion. As reported in Example 12, the emulsion strength of the protein compositions produced from full fat or HPLE soy materials had significantly greater emulsion strength than that of commercially available soy protein compositions. The emulsion strength of the soy protein compositions were at least about 20% higher than that of a soy protein composition that was defatted by a hot press method. Higher emulsion strength is required to produce meat emulsion products. The oil emulsion strength of the protein compositions was greater than 1.0 newtons, suitably greater than 1.1 newtons, more suitably greater than 1.2 newtons and even more suitably greater than 1.3 newtons as measured by the method of Example 12. All of the soy proteins produced herein may be used as protein emulsifiers in many kinds of food systems such as, meat analogs, yogurt, imitation cheeses, and the like.

The reduced-fat soy protein compositions described herein suitably have a substantially bland taste and an off-white color such that their use in production of a food product will not negatively affect the taste or color of the food product.

The centrifugal fat separation technique results in soy protein compositions that may also contain enhanced levels of beneficial microconstituents, such as isoflavones, phospholipids, saponins, tocopherols and sterols. The levels of several of the microconstituents have been evaluated.

Plant sterols are plant compounds with similar chemical structure and biological functions as cholesterol. Due to their structural similarity to cholesterol, plant sterols were first and foremost studied for their cholesterol absorption inhibition properties. In addition to their cholesterol lowering effect, plant sterols may possess anti-cancer, anti-atherosclerosis, anti-inflammation, and anti-oxidation activities. The action of plant sterols as anticancer dietary components has been recently extensively reviewed (Journal of Nutrition 2000; 130:2127-2130), and plant sterol intake was found to be inversely associated with breast, stomach, and esophageal cancers. In 1999, the FDA allowed food products containing a minimum of 6.25 grams of soy protein per serving to be labeled as reducing cholesterol and improving heart disease. Sterols in soy proteins has been found to be involved in cholesterol reduction. The protein compositions described herein have increased sterol levels, particularly as compared to hexane extracted protein compositions. See Example 10.

Reduced-fat soy extracts and reduced-fat soy protein compositions can be used to make a wide variety of food products. These food products include, but are not limited to, confectionary products, bakery products, injection meat products, emulsified meat products, ground meat products, meat analog products, cereals, cereal bars, dairy analog products, beverages, soy milk liquid or powdered dietetic formula, texturized soy products, pasta, health nutrition supplements, and nutrition bars. In particular, a confectionary product may include, but is not limited to, candy or chocolate. A bakery product may include, but is not limited to, breads, rolls, biscuits, cakes, yeast baked goods, cookies, pastries, or snack cakes. An injection meat product includes, but is not limited to ham, poultry products, turkey product, chicken product, seafood product, pork product or beef product. An emulsified meat product includes, but is not limited to sausage, bratwurst, salami, bologna, lunchmeat, or hot dogs. A ground meat product includes, but is not limited to fish sticks, meat patties, meatballs, ground pork products, ground poultry products, ground seafood products or ground beef products. A meat analog product includes, but is not limited to sausages, patties, ground meatless crumbles, lunchmeat or hot dogs. A dairy analog product includes, but is not limited to milk products, yogurt products, sour cream products, whipped topping, ice cream, cheese, shakes, coffee whitener or cream products. A dietetic formula includes, but is not limited to infant formula, geriatric formula, weight loss preparations, weight gain preparations, sports drinks, or diabetes management preparations.

An almost infinite number of several of the food products may be made by altering the ingredients in the food product. For example, a number of ready to drink beverages may be produced using the protein compositions described herein as a partial or complete protein source. Persons skilled in the art may modify the type and content of proteins, sugar sources, fats and oils, vitamin/mineral blends, flavors, gums, and/or flavors to produce a beverage product designed to meet specific nutritional requirements, product marketing claims, or targeted demographic groups. For example, nutritional bars may be produced using the soy compositions as a partial or complete protein source. Persons skilled in the art may modify the type, texture, and content of proteins, sugar sources, fats and oils, vitamin/mineral blends, flavors, coatings gums, and/or flavors to produce a nutritional bar designed to provide specific compositions to meet specific nutritional requirements, product marketing claims, or targeted demographic groups.

The fat-enriched fraction (or cream) can be processed into a crude oil by removal of at least a portion of the water from the fat-enriched fraction. The resulting crude oil is expected to have increased functionality and microconstituent content as compared to other crude oil preparations currently available. The free fatty acids value of the crude oil, as well as any oils produced from the crude oil, is generally lower than similar oils produced from hot pressed soy materials. The free fatty acids value of the oils may be measured by the standard method as described in Example 8. The starting soy material may have a free fatty acid value of less than 1.0. The resulting crude oil and products produced from the crude oil may have a free fatty acid value of about 2.0 or less, or more suitably about 1.5, 1.0, 0.7, 0.5 or less.

The crude oil may be further processed by methods known to those of skill in the art to produce a variety of compositions. The first step in processing the crude oil includes removal of phospholipids and hydratable phosphatides (“degumming”) by addition of an acid and centrifugal separation of the resulting gums. The resulting gums may be analyzed for their phospholipids and mineral content. The content of several minerals including Mg, Ca, Na, Fe, K, P and Cl may be evaluated in the gums as well as in the crude oil and the degummed oil using standard methods such as the following: AOAC 18th Ed. Method 985.35, Minerals in ready to Feed Milk Based Infant Formula, 1997, Standard Methods for the Examination of Water & WasteWater, Method 3111, Metals by Atomic Absorption Spectrophotometry, 1999, and AACC 10th Ed. Method 40-71, Sodium and Potassium by Atomic Absorption Spectrophotometry, 1999 each of which is incorporated herein by reference in its entirety. A particularly important component in the gums is soy lecithin. One measure of the quality of the gums is the amount of acetone insoluble matter present in the gums. The acetone insoluble matter in the gums can be measured as described in Example 8.

After separation, the gums may be dried and bleached or further purified to produce various types and qualities of lecithins. Lecithins are used in foods and food products as an emulsifier, stabilizer, anti-spattering agent, dough improver, anti-staling agent and antioxidant. For example, lecithins are used to promote solidity in margarine and to give consistent texture to dressings, sauces and other creamy products. Lecithins may also be used in bakery products, chocolates, instant food powders and other food product applications. Lecithin may also be used in chocolates, breads, confectionary products, instant food products and coatings and to counteract spattering during frying among other applications.

The degummed oil may be further refined to remove free fatty acids. Crude edible oils, such as soybean oil, frequently contain undesirable amounts of free fatty acids that affect their quality. The term “free fatty acids” (FFA) is used to distinguish fatty acids that are not chemically bound to glycerol molecules as carboxylic esters. FFAs are more prone to oxidation than esterified fatty acids and hence can predispose fats and oils to oxidative rancidity characterized by off-flavor described as “bitter.” Fats and oils, when pure, consist almost entirely of the esters of fatty acids and glycerol. “Fats” are solid at room temperature and “oils” are liquid at room temperature. As fats and oils are used in cooking, they tend to break down, degrade, and hydrolyze to free fatty acids, glycerol, and other polar materials. The free fatty acids are among the harmful products of this degradation.

The fatty acid composition, the total saturated and the total unsaturated fat in the various cream samples may also be determined. Fat and free fatty acids are extracted by hydrolytic methods; the fat is extracted into ether, saponified, and then methylated to fatty acid methyl esters (FAMES). FAMES are quantitatively measured by capillary gas chromatography. The procedure is based on the two following official methods: (1) AOAC 18th Edition, Method 996.06, Fat (Total, Saturated and Unsaturated) in Foods, 2001, and (2) AOCS, 5^{th} Ed., Method Ce 2-66, Preparation of Methyl Esters of Fatty Acids, 199, each of which is incorporated by reference in its entirety.

Various techniques may be employed to remove free fatty acids and other contaminants from crude fats and oils. Refining and deodorization of fats and oils are very commonly used techniques in the fat and oil industry to remove FFA. Alkali refining, used by the vast majority of European and American refiners (Braae, B., J. Am. Oil Chem. Soc 53:353 (1976); Carr, R. A., J. Am. Oil Chem. Soc. 53:347 (1976) which are incorporated herein by reference in their entireties), involves heating the fat or oil, then treating it with a concentrated caustic solution of sodium hydroxides. The crude oil is then separated from the resulting soap stock. The soap stock may be used for making soap or may be converted back to free fatty acids by treating with a strong mineral acid which can then be used as animal feed or further processed to generate distilled fatty acids.

The refined oil fraction may then be bleached by treatment with solid absorbents such as activated carbon that may then be removed by filtration. Deodorization, very commonly used in the fats and oils industry to remove odorous substances from the crude oil, may be accomplished by steam distillation of heated oil under a high vacuum. The deodorization process simultaneously removes the FFAs, fat-soluble vitamins (A, E, D, K), mono-glycerides, sterols, and some pigments such as carotenoids. Deodorization also strips off the aroma and flavors of fats and oils resulting in a bland finished product. The free fatty acid content for edible fats and oils is a key factor in the quality, flavor, and odor of those fats and oils. The resulting refined, bleached and deodorized (RBD) oils can be used as salad or cooking oil and also in a variety of food product applications as would be apparent to those of skill in the art.

The following examples are meant only to be illustrative and are not intended to limit the scope of the invention.

### EXAMPLE 1

### Preparation of Reduced Fat Soy Protein Products from Extruder Pressed Soy Flour Using the Acid Precipitation Process.

Partially defatted, extruder pressed soy flour was obtained from Natural Products, Inc., (lot number 092605, Grinnell, Iowa). Dehulled soybean pieces were partially defatted using a mechanical extruder-press (Instapro™ Dry Extruder and Continuous Horizontal Press, Des Moines, Iowa). The partially defatted soy cake was ground into a 100 mesh partially defatted soy flour with proximate analysis of 5.0% moisture, 54.0% dry basis Kjeldahl protein, 11.7% dry basis acid hydrolyzed fat and a 4.6 to 1 protein to fat ratio.

In this and all subsequent examples, the dry basis protein and fat ratios were measured by standard methods. The protein content of the soy materials was determined using the Kjeldahl method (AOAC 18th Ed. Method 991.2.2, Total Nitrogen in Milk, 1994, which is incorporated herein by reference in its entirety). Briefly, samples were digested using acid, catalyst and heat. The digested sample was made alkaline with the addition of sodium hydroxide. Steam was then used to distill the sample, releasing ammonia. The ammonia was collected in a receiving vessel and was back titrated with a standardized acid solution. The nitrogen content was then calculated. The protein content was determined by multiplying the nitrogen content by a protein factor (i.e. 6.25 for soy materials). The fat content of the soy materials was determined gravimetrically. Briefly, the sample was weighed into a Mojonnier flask. Acid was added and the sample was heated until the solids are broken down. The sample was cooled and then extracted using alcohol, ethyl ether and pet ether. The flask was centrifuged and the resulting ether/fat layer was poured off into a pre-weighed aluminum dish. Samples were subjected to a series of 2 or 3 extractions, depending on the fat level. The ether was evaporated and placed in an oven to dry. The sample was cooled in a desiccator and then weighed as described in the Official Method of Analysis AOAC 922.06, Fat in Flour, which is incorporated herein by reference in its entirety. In addition, the total solids present in the soy material were determined gravimetrically using standard procedures. Briefly, the sample was weighed and placed in an oven at a specific temperature for a specific time, depending on the sample type. For powder samples, a vacuum oven set at 100° C. for 5 hours was used. The sample was removed from the oven and cooled in a desiccator. The cooled sample was weighed and the total solids/moisture was calculated as describe in official methods of analysis, Association of Official Analytical Chemists (AOAC), 18th Edition 927.05, Moisture in Dried Milk which is incorporated herein by reference in its entirety.

Fifty pounds of the partially defatted soy flour was extracted with 640 pounds of tap water at 120° F. in a 100 gallon agitated tank. The pH of the extraction slurry was adjusted to 10.3 by adding one pound of calcium hydroxide (CODEX HL, Mississippi Lime Company, Saint Genevieve, Mo.) and held for a mean time of 2 hours. The soy extract was separated from the insoluble by-product (okara) using a high g-force, disk-type clarifying centrifuge (model SB-7, Westfalia Separator Industry GmbH, Oelde, Germany) at an extract flow rate of 5.5 pounds per minute with intermittent solids discharge of 2.5 seconds duration on a 5 to 8 minute cycle. The insoluble by-product (20.2 pounds of solids) was collected and contained 17.3% solids and 45.8% Kjeldahl dry basis protein.

The soy extract was heated to 150° F. and delivered to a high g-force continuous discharge, disk-type separator (model MP-1254, Westfalia Separator Industry GmbH, Oelde, Germany) for separation of the fat. The separator was configured either as a hot milk or cold milk separator with a 52.5 degree disk stack angle to the horizontal with 0.5 mm spacing between the disks and a solid bowl with no solids discharge. The separator was fed at a rate of 16 pounds per minute, separating the soy cream (fat-enriched fraction) from the reduced-fat soy extract. Sixty-nine percent of the fat in the soy extract was removed in the soy cream producing a reduced-fat soy extract. The reduced-fat soy extract contained a protein to fat ratio of 18.6 to 1 with a 60.2% Kjedahl dry basis protein and 3.2% dry basis acid hydrolyzed fat.

The reduced-fat soy extract was precipitated by adding citric acid powder (Citric Acid, Anhydrous FCC grade, Xena International, Inc., Polo, Ill.) to a pH of 4.5 in an agitated tank at 140° F. The mixture was held for ten minutes with mild agitation, and then fed continuously to a high g-force disk-type clarifying centrifuge (model SB-7, Westfalia Separator Industry GmbH, Oelde, Germany) at a first whey flow rate of 5.5 pounds per minute with intermittent solids discharge of 2.5 seconds duration on a 6 to 10 minute cycle to separate the curd (precipitated protein) from the whey. The recovered curd, also known as the first soy protein composition, weighed 17.4 pounds and represented a soy protein concentrate with 83.6% dry basis Kjeldahl protein and 6.2% dry basis acid hydrolyzed fat. The protein to fat ratio of the first soy protein composition was 13.5 to 1.

The first soy protein composition was diluted with fresh hot water at a temperature of 130° F. to about 5% solids, and this rehydrated first soy protein composition was continuously fed to a high g-force clarifying centrifuge (model SB-7, Westfalia Separator Industry GmbH, Oelde, Germany) at a second whey flow rate of 5.5 pounds per minute with intermittent solids discharge of 2.5 seconds duration on a 6 to 10 minute cycle to separate the curd (second soy protein composition) and the whey. Fifteen point three pounds of the second soy protein composition was recovered and constituted a soy protein isolate with 92.5% dry basis Kjeldahl protein and 6.1% dry basis acid hydrolyzed fat. The protein to fat ratio of the second soy protein composition was 15.1 to 1.

The second soy protein composition was modified by adjusting the solids level to about 12% with fresh water at 70° F., and adjusting the pH to 7.1 with a 10% solution of sodium hydroxide (50% solution, Fisher Scientific, Barnstead International, Dubuque, Iowa). The product was pasteurized in a continuous process with a two-stage plate and frame heat exchanger (model 25HV, Microthermics, Inc, Raleigh, N.C.). The neutralized soy protein composition was heated in the first heat exchanger to 195° F., then homogenized (model NS2006H, NIRO Soavi, Hudson, Wis.) in a two stage process with 2500 psi and 500 psi homogenization pressure, respectively. The homogenized plant protein composition was heated in the second stage of the heater to a temperature of 285° F., held for 6 seconds, and cooled to less than 110° F. before spray drying.

The modified soy protein isolate was immediately fed to the spray drier (model 1, NIRO Atomizer, Hudson, Wis.) at a feed rate of 40 pounds per hour using a high revolution wheel atomizer. Spray drier inlet air temperature was maintained at 200° C. with outlet air temperature of 92° C. to attain product moisture of 3.5% in the soy isolate powder.

### EXAMPLE 2

### Preparation of Reduced-Fat Soy Protein Compositions from High Pressure Liquid Extraction Soy Cake Using the Acid Precipitation Process.

Partially defatted soy cake was obtained from SafeSoy Technologies (lot number SS, Ellsworth, Iowa). Dehulled soybean pieces were partially defatted using a high pressure liquid extractor (prototype model, Crown Iron Works, Minneapolis, Minn.). High pressure liquid extraction is a continuous screw press method using carbon dioxide as a solvent under high pressure, but less than super critical conditions, to remove fat from oilseeds. The partially defatted HPLE soy cake was milled to a flour as in Example 1 and had proximate analysis of 9.59% moisture, 52.1% dry basis Kjeldahl protein, and 6.6% dry basis acid hydrolyzed fat for a protein to fat ratio of 5.4 to 1.

Fifty pounds of the partially defatted soy flour was extracted with 800 pounds of water at 125° F. in a 100 gallon agitated tank. The pH of the extraction slurry was adjusted to 8.65 by addition of 0.5 pound of calcium hydroxide and the mixture was held for a mean time of 1 hour. The soy extract was separated from the insoluble by-product (okara) using high a g-force, disk-type clarifying centrifuge as described in Example 1. Twenty six point three pounds of insoluble by-product solids was collected and contained 16.87% solids and 47.8% Kjeldahl dry basis protein.

The soy extract was heated to 125° F. and delivered to a high g-force continuous discharge, disk-type separator for centrifugal fat separation as described in Example 1. The separator was fed at a rate of 8.5 pounds per minute, separating the fat-enriched fraction from the reduced-fat extract. Forty-five percent of the fat in the soy extract was removed producing a reduced-fat soy extract. The reduced-fat soy extract contained a protein to fat ratio of 16.5 to 1 and was 58.1% Kjeldahl dry basis protein and 3.5% dry basis acid hydrolyzed fat.

The reduced-fat soy extract was precipitated by adding citric acid powder to a pH of 4.65 in an agitated tank at 130° F. The precipitated protein was held for 15 minutes with mild agitation, and then fed continuously to a high g-force disk-type clarifying centrifuge as described in Example 1. Twelve point one pounds of first curd solids (first soy protein composition) was recovered and the resulting product was a soy protein concentrate with 82.0% dry basis Kjeldahl protein, 6.5% dry basis acid hydrolyzed fat and a protein to fat ratio of 12.7 to 1.

The first soy protein composition was diluted with fresh hot water to a temperature of 130° F. to 2.6% solids and was continuously fed to a high g-force clarifying centrifuge as described in Example 1 to produce a second soy protein composition. Ten pounds of the second protein composition solids was recovered as a soy protein isolate with 94.3% dry basis Kjeldahl protein, 6.2% dry basis acid hydrolyzed fat and a protein to fat ratio of 15.3 to 1.

The second soy protein composition was modified by adjusting the solids level to 9.09% with fresh water at 90° F., and adjusting the pH to 7.03 with a 10% solution of sodium hydroxide. The product was pasteurized, homogenized, and spray dried as described in Example 1.

### EXAMPLE 3

### Preparation of Reduced-Fat Soy Protein Compositions from Full Fat Soy Flour Using the Acid Precipitation Process.

Full fat soy flour was obtained from Natural Products Inc. (lot number 112105, Grinnell, Iowa), and was produced from certified organic whole soybeans. Dehulled soybean pieces were milled to 600 mesh flour. The resulting full fat soy flour contained 8.83% moisture, 43.9% dry basis Kjeldahl protein, and 25.5% dry basis acid hydrolyzed fat for a protein to fat ratio of 1.7 to 1.

Fifty pounds of full fat soy flour was extracted with 800 pounds of water at 125° F. in a 100 gallon agitated tank. The pH of the extraction slurry was adjusted to 9.35 by addition of 0.5 pound of calcium hydroxide and held for a mean time of 1 hour. The soy extract was separated from the insoluble by-product using a high g-force, disk-type clarifying centrifuge as described in Example 1. Ten pounds of insoluble by-product solids was collected and discarded at 15.29% solids, 16.0% Kjeldahl dry basis protein.

The soy extract was heated to 125° F. and delivered to a high g-force continuous discharge, disk-type separator as described in Example 1 for separation of the fat-enriched fraction. The separator was fed at a rate of 10 to 27 pounds per minute with acceptable performance, separating the fat-enriched fraction from the reduced-fat extract. Seventy three percent of the fat in the soy extract was removed. The reduced-fat soy extract contained a protein to fat ratio of 8.4 to 1. The reduced-fat extract had a proximate value of 62.4% Kjeldahl dry basis protein and 7.4% dry basis acid hydrolyzed fat.

The reduced-fat soy extract was precipitated by adding citric acid powder to adjust the pH to 4.54 in an agitated tank at 120° F. The mixture was held for 35 minutes with mild agitation, and then fed continuously to a high g-force disk-type clarifying centrifuge as previously described in Example 1. Nineteen point four pounds of first soy protein composition solids was recovered and is a soy protein concentrate with 84.4% dry basis Kjeldahl protein, 12.5% dry basis acid hydrolyzed fat and a protein to fat ratio of 6.7 to 1.

The first soy protein composition was diluted with fresh hot water to a temperature of 125° F. to 3.41% solids and continuously fed to a high g-force clarifying centrifuge as previously described in Example 1. Sixteen point six pounds of the second soy protein composition solids was recovered as a soy protein isolate with 90.5% dry basis Kjeldahl protein, 9.0% dry basis acid hydrolyzed fat, and a protein to fat ratio of 10.3 to 1.

The second soy protein composition was modified by adjusting the solids level to 10.32% with fresh water at 90° F., and adjusting the pH to 6.9 with a 10% solution of sodium hydroxide. The product was pasteurized, homogenized, and spray dried as previously described in Example 1.

### EXAMPLE 4

Preparation of Reduced-Fat Soy Protein Composition from Full Fat Soy Flour by the Ultrafiltration Process.

Full fat soy flour was obtained from Natural Products Inc. (lot number 011106, Grinnell, Iowa), and was produced from certified organic whole soybeans which were processed into a full fat soy flour as identified in Example 3. The full fat soy flour had proximate analysis of 8.78% moisture, 42.9% dry basis Kjeldahl protein, and 26.6% dry basis acid fat for a protein to fat ratio of 1.6 to 1.

Twenty-five pounds of full fat soy flour was extracted with 400 pounds of water at 125° F. in a 100 gallon agitated tank. The pH was adjusted to 9.0 by adding 0.2 pound of calcium hydroxide and held for a mean time of 40 minutes. The soy extract was separated from the insoluble by-product using a high g-force, disk-type clarifying centrifuge as described in Example 1. Four point six pounds of insoluble by-product was collected at 14.52% solids and 17.1% Kjeldahl dry basis protein.

The soy extract was heated to 125° F. and delivered to a high g-force continuous discharge, disk-type separator as described in Example 1 for the separation of fat. The separator was fed at a rate of 20 pounds per minute, separating the fat-enriched fraction from the reduced-fat extract. Seventy three percent of the fat in the soy extract was removed. The reduced-fat soy extract contained a protein to fat ratio of 8.0 to 1 with a 59.4% Kjeldahl dry basis protein level and 7.4% dry basis acid hydrolyzed fat.

The reduced-fat soy extract was further processed by passing it through a microporous ultrafiltration membrane system (model system 1515, PTI Advanced Filtration, San Diego, Calif.) installed with two spiral wound Polysulfone membranes with molecular weight cutoff of 10,000 (43 mil spacer, 5.7 square meters filtration area, PTI Advanced Filtration, San Diego, Calif.). Three hundred forty one and one half pounds of reduced-fat soy extract was transferred to a feed tank at 107° F., 8.5 pH, and 3.25% solids. A feed pump recirculated the extract at 35-40 gallons per minute with a differential pressure drop across the membrane filter of 16-17 pounds per square inch. The retentate off the membranes was returned to the feed tank, and the first permeate was discharged until 279 pounds of first permeate was removed, or 81.6% of the original weight of reduced-fat soy extract. The process was completed in 41 minutes. Eleven pounds of the first retentate solids were recovered at a 79.2% Kjeldahl dry basis protein, constituting a soy concentrate with 9.2% dry basis acid hydrolyzed fat for a protein to fat ratio of 8.6 to 1.

The first retentate was diluted by adding 279 pounds of deionized water at 107° F., and a second ultrafiltration was carried out using the same conditions as the first separation. The diluted first retentate was recirculated to the membranes until 269 pounds of second permeate was removed in 42 minutes, or 78.8% of the diluted first retentate. A total of 96.9% of the original weight of the reduced-fat soy extract was removed in the two-stage ultrafiltration process. Ten point one pounds of second retentate were recovered with 85.7% Kjeldahl dry basis protein content, constituting a soy concentrate with 9.8% dry basis acid hydrolyzed fat yielding a protein to fat ratio of 8.7 to 1.

The second retentate was modified by adjusting the solids level to 9.2% with fresh water at 90° F., and adjusting the pH to 7.0 with a 10% solution of sodium hydroxide. The product was pasteurized, homogenized and spray-dried as described in Example 1.

### EXAMPLE 5

### Preparation of a Soy Protein Product from Full Fat Soy Flour Using a Microfiltration Process.

Full fat soy flour was obtained from Natural Products Inc., Grinnell, Iowa, and was produced from certified organic whole soybeans which were processed into a full fat soy flour as identified in Example 3. The full fat soy flour had proximate analysis of 8.0% moisture, 42.5% dry basis Kjeldahl protein, and 26.4% dry basis acid fat for a protein to fat ratio of 1.6 to 1.

Fifty pounds of full fat soy flour was extracted with 800 pounds of water at 125° F. in a 100 gallon agitated tank. The pH was adjusted to 8.6 by adding 0.32 pounds of calcium hydroxide and held for a mean time of 3 hours. The soy extract was separated from the insoluble by-product using a Sharples P-660 horizontal decanter operating at 4390 rpm with backdrive setting of 1000 rpm with a Triclover positive gear pump model PRED-10 feed pump setting of 1.0-1.2. Fourteen point six pounds of insoluble by-product solids was collected at 9.7% solids and 23.5% Kjeldahl dry basis protein.

The soy extract was heated to 125° F. and delivered to a high g-force continuous discharge, disk-type separator as described in Example 1 for the separation of fat. The separator was fed at a rate of 20 pounds per minute, separating the fat-enriched fraction from the reduced-fat extract. Seventy three percent of the fat in the soy extract was removed. The reduced-fat soy extract contained a protein to fat ratio of 5.2 to 1 with a 58.8% Kjeldahl dry basis protein level and 11.4% dry basis acid hydrolyzed fat. A protein-fat sediment was obtained from the separator with 52.2% dry basis protein, 30.6% dry basis fat, and 12.6% total dietary fiber.

The reduced-fat soy extract was further processed by passing it through a microporous microfiltration membrane system (model system 1515, PTI Advanced Filtration, San Diego, Calif.) installed with two spiral wound polyvinylidene flouride membranes type FG with molecular weight cutoff of 300,000 (0.3 microns, Dominick Hunter, San Diego, Calif.). Two hundred thirteen pounds of reduced-fat soy extract was transferred to a feed tank at 99° F., 8.5 pH, and 3.52% solids. A feed pump recirculated the extract at 39-41 gallons per minute with a differential pressure drop across the membrane filter of 18-19 pounds per square inch. The retentate off the membranes was returned to the feed tank, and the first permeate was discharged until 153 pounds of first permeate was removed, or 71.8% of the original weight of reduced-fat soy extract. The process was completed in 15 minutes. Six pounds of the first retentate solids were recovered at a 70.0% Kjeldahl dry basis protein, constituting a soy concentrate with 14.4% dry basis acid hydrolyzed fat for a protein to fat ratio of 4.9 to 1.

The first retentate was diluted by adding 240 pounds of deionized water at 107° F., and a second ultrafiltration was carried out using the same conditions as the first separation. The diluted first retentate was recirculated to the membranes until 268 pounds of second permeate was removed in 31 minutes, or 89.3% of the diluted first retentate. A total of 96.9% of the original weight of the reduced-fat soy extract was removed in the two-stage microfiltration process. Five point one pounds of second retentate were recovered with 79.2% Kjeldahl dry basis protein content, constituting a soy concentrate with 15.7% dry basis acid hydrolyzed fat yielding a protein to fat ratio of 5.0 to 1.

The second retentate was modified by adjusting the solids level to 10.2% with fresh water at 90° F., and adjusting the pH to 7.0 with a 10% solution of sodium hydroxide. The product was pasteurized, homogenized and spray-dried as described in Example 1. Less than 2% of the fat present in the reduced-fat extract was removed in the microfiltration permeates. Surprisingly, 87.8% of the protein in the reduced-fat extract was maintained in the retentate through two microfiltration steps with very large, 0/3 micron pore sizes. This indicates that the soy proteins are in their native, globular state with very high molecular weights.

### EXAMPLE 6

Preparation of Reduced-Fat Glycinin-Rich Soy Protein Fractions and Beta-Conglycinin-Rich Soy Protein Fractions from full Fat Soy Flour.

To produce a reduced-fat glycinin rich fraction from full fat soy flour, 3.5 lb of reduced fat soy extract having 57.5% Kjeldahl dry basis protein and 11.4% dry basis acid hydrolyzed fat (protein to fat ratio of 5.0 to 1) was prepared according to Example 3, and was heated to 60° C. Sodium sulfite (0.1% solids by weight) was added to the extract at pH 7.2 and mixed for about 10 minutes. The pH was adjusted to 5.5 using a 50% citric acid solution and produced a glycinin-rich precipitate which was separated from the supernatant by centrifuging at 4000 rpm in an IEC model K lab centrifuge. The glycinin-rich solids contained 11.4% dry solids with a 70.7% Kjeldahl dry basis protein and 13.4% dry basis acid hydrolyzed fat for a protein to fat ratio of 5.2 to 1. The pH of the supernatant was then adjusted to 4.8 by the addition of 50% citric acid solution to precipitate a fraction rich in beta-conglycinin which was also separated and recovered by centrifugation as described above. The beta-conglycinin fraction contained 17.1% dry solids with a 69.6% Kjeldahl dry basis protein and 17.1% dry basis acid hydrolyzed fat for a protein to fat ratio of 4.1 to 1.

### EXAMPLE 7

### Evaluation of the Surface Hydrophobicity of Soy Protein Compositions

Hexane extracted soy flour (type 100/90) was obtained from Cargill, Minneapolis. Full fat soy flour was obtained from Natural Products Inc., Grinnell, Iowa, and was produced from certified organic whole soybeans and was processed as in Example 3. Partially defatted extruder pressed soy flour was obtained from Natural Products Inc., Grinnell, Iowa. Partially defatted HPLE soy flour was obtained from SafeSoy Technologies, Ellsworth, Iowa. All four soy flours were processed using identical methods, except that the soy extract prepared from the full fat flour was separated into a cream and reduced-fat extract as in Example 3.

Briefly, each of the four soy flours was extracted with a total of 16 parts of water at 125° F. to each part of soy flour. The pH of each extraction slurry was adjusted to 7.1-7.7 by addition of calcium hydroxide and held for a mean time of 30 minutes. The soy flour extracts were separated from the insoluble by-products (okara) using a high g-force centrifugation. The soy extract produced from the full fat flour was further processed in a separator to remove the cream as in Example 3.

Each extract was precipitated by adding a 50% citric acid solution to a pH of 4.5 at 140° F. The mixtures were held for twenty minutes with mild agitation, and then centrifuged to separate the curd (precipitated protein) from the first whey. The first protein compositions were diluted with water at 140° F. back to one-half of their original extract volumes. The mixture from each diluted first protein composition was held for ten minutes with mild agitation, and then centrifuged to separate the second curd (precipitated protein) from the second whey. The second plant protein composition (soy isolate) from each flour was modified by adjusting the solids level to 10% with fresh water at 90° F., and adjusting the pH to 6.8 with sodium hydroxide followed by freeze drying as in Example 6.

The freeze dried second protein compositions produced from the four raw materials were evaluated for protein and fat composition as in Example 1, and analyzed using a fluorescence probe method to determine the surface hydrophobicity. Briefly, determination of soy protein surface hydrophobicity was carried out using ANS (1-anilinonaphthalene-8-sulfonate) as a fluorescence probe. A series of dilutions of soy protein samples were prepared with phosphate buffer (0.01 M, pH 7) to obtain protein concentrations ranging from 0 to 1000 μg/ml. Twenty μl of ANS (16 mM) was added to 5 mL of each sample. The ANS-protein conjugates were excited at 365 nm and the fluorescence intensity was measured at 484 nm in an Aminco-Bowman spectrofluorometer (Aminco-Bowman Series 2 Luminescence spectrometer, Thermo Electron Corporation, MA). The initial slope of the plot of fluorescence intensity versus protein concentration was calculated as the surface hydrophobicity (S0).

Very good correlations were observed for the protein surface hydrophobicity determined fluorimetrically with the interfacial tension and emulsifying activity of the proteins.

TABLE 1
SURFACE HYDROPHOBICITY

| | | | Surface Hydrophobicity |
|---|---|---|---|
| | | | slope of the |
| | % Protein | | florescence vs. |
| Raw Materials | dry basis | % Fat | protein concentration |
| Full Fat Soy Flour | 88.5 | 13.2 | 115 |
| Hexane Defatted Soy Flour | 95.1 | 3.1 | 94 |
| HPLE Soy Flour | 88.1 | 14.0 | 78 |
| Expeller Pressed Soy Flour | 80.8 | 17.5 | 77 |

The surface hydrophobicity of the protein composition prepared from full fat soy flour is 47% greater than that of the protein composition prepared from HPLE or expeller pressed soy flour, and 22% greater than the protein composition prepared from hexane defatted soy flour.

### EXAMPLE 8

### Preparation of Degummed Soybean Oil and Soy Gums (Lecithin) from the Cream Fraction of the Fat Separation Process Compared with Expeller Pressed and Hexane Extracted Crude Oil.

Two aliquots of soy cream were obtained using the method of Example 3 from full fat soy flour. Hexane extracted crude oil was obtained from CHS Oilseed Processors, Mankato, Minn. and expeller pressed crude oil was obtained from American Natural Soy. Inc., Cherokee, Iowa. Soy creams from two different trials were produced using the procedure of Examples 3, and were freeze dried (as in Example 6) to evaporate the water and produce a crude oil. The freeze dried crude oils, the commercially produced expeller pressed crude oil, and the hexane extracted crude oil were separately heated to 150° F. and agitated. Two percent by weight of a 5% citric acid solution was added to the agitated beaker for 15 minutes. The phospholipids (soy lecithin, also known as gums) were then removed as solids by centrifugation at 4000 rpm for 10 minuets in a lab centrifuge as described in Example 6, and the supernatant oil was filtered over filter paper as a degummed soy oil. Crude oil, degummed oil, and the separated gums were analyzed for their chemical properties for each of the four samples.

The fat, protein and solids content of the samples were determined by the methods detailed in Example 1. The free fatty acid value indicates the amount of hydrolytic rancidity that has occurred in a fat. The free fatty acid value was calculated based on the two following official methods of analysis: (1) AOAC method 41.1.21 and (2) Official Methods and Recommended Practices of the American Oil Chemists Society, 5th Ed., Method Ca 5a-40 each of which is incorporated herein by reference in its entirety. Hydrolytic rancidity is caused by enzyme hydrolysis of fats into free fatty acids and glycerol. Briefly, the test involves dissolving a fat sample in organic solvent and titrating with sodium hydroxide. Free fatty acid can be expressed in terms of an acid value instead of percent free fatty acids as in Tables 3 and 4. The acid value is defined as mg of potassium hydroxide (KOH) necessary to neutralize one gram of sample. To convert percent free fatty acids (as oleic) to an acid value, multiply the percent free fatty acids by 1.99.

The mineral content of the crude oil, the degummed oil and the gums was determined using standard methods such as the following: AOAC 18th Ed. Method 985.35, Minerals in ready to Feed Milk Based Infant Formula, 1997, Standard Methods for the Examination of Water & WasteWater, Method 3111, Metals by Atomic Absorption Spectrophotometry, 1999, and AACC 10th Ed. Method 40-71, Sodium and Potassium by Atomic Absorption Spectrophotometry, 1999 each of which is incorporated herein by reference in its entirety.

The levels of acetone insoluble matter present in the soy gums were determined using the following method. The gums were warmed briefly at a temperature not exceeding 60° C. and then mixed. Two grams were transferred to a 40-mL centrifuge tube and 15.0 mL of acetone was added. The resulting sample was warmed in a water bath with stirring to melt the gums completely and then placed in an ice-water bath for 5 minutes. Acetone chilled to between 0° and 5° C. was then added to the 40-mL mark on the centrifuge tube with stirring. The tube was then incubated in an ice-water bath for 15 minutes, stirred, and centrifuged at 2000 rpm for 5 minutes. The supernatant was decanted and the pellet broken up. The centrifuge tube was then refilled with chilled acetone to the 40 mL mark while stirring. After incubation in an ice-water bath for 15 minutes, the tube was centrifuged again, the supernatant was decanted and the remaining acetone was allowed to evaporate. The tube containing the acetone-insoluble residue was heated to 105° C. and the weight of the acetone insoluble residue determined. The percentage of acetone-insoluble matter can then be calculated by comparison to the starting weight.

TABLE 2
CRUDE SOY OIL COMPARISONS

| | | | % | | FREE FATTY |
|---|---|---|---|---|---|
| | | % | OTHER | PHOSPHOROUS | ACIDS |
| | % FAT | PROTEIN | dry basis | mg per 100 grams | Acid value |
| FREEZE DRIED CREAM 1 | 88.00% | 5.41% | 6.59% | 69 | 0.440 |
| (PRODUCED USING THE | | | | | |
| PROCESS OF EXAMPLE 3) | | | | | |
| FREEZE DRIED CREAM 2 | 86.94% | 3.08% | 9.98% | 45 | 0.360 |
| (PRODUCED USING THE | | | | | |
| PROCESS OF EXAMPLE 3) | | | | | |
| HEXANE EXTRACTED | 99.12% | 0.22% | 0.66% | 53 | 0.500 |
| CRUDE OIL - CHS | | | | | |
| OILSEED PROCESSORS | | | | | |
| EXPELLER PRESSED | 97.04% | 0.21% | 2.75% | 82 | 3.810 |
| CRUDE OIL - AMERICAN | | | | | |
| NATURAL SOY | | | | | |

TABLE 3
DEGUMMED SOY OIL COMPARISONS

| | | | % | | FREE FATTY |
|---|---|---|---|---|---|
| | | % | OTHER | PHOSPHOROUS | ACIDS |
| | % FAT | PROTEIN | dry basis | mg per 100 grams | Acid value |
| FREEZE DRIED CREAM 1 | 99.88% | 0.01% | 0.11% | <3.0 | 0.400 |
| FREEZE DRIED CREAM 2 | 99.72% | 0.01% | 0.27% | 4.20 | 0.470 |
| HEXANE EXTRACTED | 99.97% | 0.01% | 0.02% | <3.0 | 0.420 |
| CRUDE OIL | | | | | |
| EXPELLER PRESSED | 99.66% | 0.01% | 0.37% | <3.0 | 1.550 |
| CRUDE OIL | | | | | |

TABLE 4
SOY LECITHIN (GUMS)

| | | | % | | |
|---|---|---|---|---|---|
| | | % | OTHER | PHOSPHOROUS | ACETONE |
| GUMS PRODUCED FROM | % FAT | PROTEIN | dry basis | mg per 100 grams | INSOLUBLES |
| FREEZE DRIED CREAM 1 | 84.72% | 9.73% | 5.54% | 123 | 18.34% |
| FREEZE DRIED CREAM 2 | 86.26% | 9.16% | 4.58% | 106 | 15.97% |
| HEXANE EXTRACTED | 80.13% | 2.40% | 17.47% | 635 | 53.5% |
| CRUDE OIL | | | | | |
| EXPELLER PRESSED | 73.43% | 4.42% | 22.15% | 1710 | 65.75% |
| CRUDE OIL | | | | | |

The free fatty acid value of the crude oils prepared from the soy creams are 12 to 28% less than the hexane extracted crude oil, and 88 to 90% less than the expeller pressed crude oil. The free fatty acid content for edible fats and oils is a key factor in the quality, flavor, and odor of these food ingredients.

Degummed soy oils prepared from the creams are similar in composition to the hexane extracted and expeller pressed crude oils. The degummed crude oil fraction can be refined, bleached, deodorized, or undergo any further processing to purify the oil obtained from the cream fraction.

The soy lecithins (gums) produced from the soy creams contain higher levels of protein, reduced levels of other constituents, and lower content of insoluble materials than the expeller pressed and hexane extracted crude oils. The precipitated gums can be used as a feed additive, or evaporated to remove moisture.

### EXAMPLE 9 (PROPHETIC)

### Preparation of Low-Fat and No-Fat Soymilk Consumer Products from Reduced-Fat Soy Extracts and/or Soy Isolates Prepared in Examples 1 through 5 Compared to Commercially Available Soymilk Powder.

Soymilk products are prepared from a liquid extract of whole soybeans or alternatively rehydrated soy proteins that are wet blended with other ingredients. The minimum quantity of soy proteins utilized in the production of commercial soymilk is equal to the amount of protein necessary to consume a minimum of 6.25 grams of soy protein in a single serving of 240 ml of the commercial soymilk. Using the soy proteins produced in Examples 1 through 5 with the minimum 6.25 grams of soy protein per serving, commercial soymilk products may be prepared from rehydrated soy protein isolates according to the formulas in Table 5.

TABLE 5
SOYMILK PRODUCT FORMULAS

| INGREDIENTS | EXAMPLE 1 | EXAMPLE 2 | EXAMPLE 3 | EXAMPLE 4 | EXAMPLE 5 |
|---|---|---|---|---|---|
| WATER | 88.74% | 88.94% | 88.80% | 88.63% | 88.52% |
| SOY PROTEIN | 2.95% | 2.75% | 2.89% | 3.06% | 3.17% |
| SUGARS | 5.00% | 5.00% | 5.00% | 5.00% | 5.00% |
| GUMS | 2.00% | 2.00% | 2.00% | 2.00% | 2.00% |
| VITAMIN/MINERAL | | | | | |
| FORTIFICATION | 1.30% | 1.30% | 1.30% | 1.30% | 1.30% |
| FLAVORINGS | 0.01% | 0.01% | 0.01% | 0.01% | 0.01% |

The soymilk products produced using these formulas have the product compositions identified in Table 6.

TABLE 6
SOYMILK PRODUCT COMPOSITIONS

| | EXAMPLE 1 | EXAMPLE 2 | EXAMPLE 3 | EXAMPLE 4 | EXAMPLE 5 |
|---|---|---|---|---|---|
| PROTEIN, AS IS | 2.53% | 2.53% | 2.53% | 2.53% | 2.53% |
| FAT, AS IS | 0.19% | 0.18% | 0.25% | 0.29% | 0.49% |
| CARBOHYDRATE, AS IS | 7.00% | 7.00% | 7.00% | 7.00% | 7.00% |
| PROTEIN TO FAT RATIO | 13.2 | 14.2 | 10.1 | 8.7 | 5.2 |
| NUTRIENTS PER 240 ML | | | | | |
| SERVING | | | | | |
| CALORIES | 95.6 | 95.3 | 96.9 | 97.8 | 102.0 |
| CALORIES FROM FAT | | | | | |
| | GRAMS | GRAMS | GRAMS | GRAMS | GRAMS |
| TOTAL FAT | 0.46 | 0.43 | 0.60 | 0.70 | 1.17 |
| SATURATED FAT | 0 | 0 | 0 | 0 | 0 |
| CHOLESTEROL | 0 | 0 | 0 | 0 | 0 |
| TOTAL CARBOHYDRATE | 17.3 | 17.3 | 17.3 | 17.3 | 17.3 |
| DIETARY FIBER | 0 | 0 | 0 | 0 | 0 |
| SUGARS | 12.4 | 12.4 | 12.4 | 12.4 | 12.4 |
| PROTEIN | 6.3 | 6.3 | 6.3 | 6.3 | 6.3 |

The soymilk produced from soy proteins derived from Examples 1 and 2 contain less than 0.5 grams of acid hydrolyzed fat per serving and thus are considered to be fat free soymilk under USDA Food Pyramid guidelines. All five soymilk products are low-fat soymilk products.

Soymilks may also be produced from the reduced-fat soy extracts produced in Examples 1 through 5 according to the formulas in Table 7. For comparison a commercially available lowfat organically certified soymilk powder is included in Table 7.

TABLE 7
SOYMILK PRODUCT FORMULAS

| | | | | | | SOYMILK |
|---|---|---|---|---|---|---|
| INGREDIENTS | EXAMPLE 1 | EXAMPLE 2 | EXAMPLE 3 | EXAMPLE 4 | EXAMPLE 5 | POWDER |
| WATER | 87.49% | 87.34% | 87.64% | 87.43% | 87.39% | 86.67% |
| REDUCED-FAT SOY | | | | | | |
| EXTRACT SOLIDS | 4.20% | 4.35% | 4.05% | 4.26% | 4.30% | |
| BENESOY LOW-FAT | | | | | | |
| SOYMILK POWDER | | | | | | 5.02% |
| SUGARS | 5.00% | 5.00% | 5.00% | 5.00% | 5.00% | 5.00% |
| GUMS | 2.00% | 2.00% | 2.00% | 2.00% | 2.00% | 2.00% |
| VITAMIN/MINERAL | | | | | | |
| FORTIFICATION | 1.30% | 1.30% | 1.30% | 1.30% | 1.30% | 1.30% |
| FLAVORINGS | 0.01% | 0.01% | 0.01% | 0.01% | 0.01% | 0.01% |

Soymilk products produced from the reduced-fat soy extracts and the commercially available soymilk powder have the following compositions identified in Table 8.

TABLE 8
SOYMILK PRODUCT COMPOSITIONS

| | | | | | | SOYMILK |
|---|---|---|---|---|---|---|
| | EXAMPLE 1 | EXAMPLE 2 | EXAMPLE 3 | EXAMPLE 4 | EXAMPLE 5 | POWDER |
| PROTEIN, AS IS | 2.53% | 2.53% | 2.53% | 2.53% | 2.53% | 2.53% |
| FAT, AS IS | 0.13% | 0.15% | 0.30% | 0.32% | 0.49% | 0.73% |
| CARBOHYDRATE, AS IS | 7.00% | 7.00% | 7.00% | 7.00% | 7.00% | 7.80% |
| PROTEIN TO FAT RATIO | 18.8 | 16.6 | 8.4 | 8.0 | 5.2 | 3.5 |
| NUTRIENTS PER 240 ML | | | | | | |
| SERVING | | | | | | |
| CALORIES | 94.4 | 94.8 | 98.0 | 98.3 | 102.1 | 115.0 |
| CALORIES FROM FAT | 2.9 | 3.3 | 6.5 | 6.8 | 10.6 | 15.8 |
| | GRAMS | GRAMS | GRAMS | GRAMS | GRAMS | GRAMS |
| TOTAL FAT | 0.32 | 0.37 | 0.72 | 0.76 | 1.18 | 1.75 |
| SATURATED FAT | 0 | 0 | 0 | 0 | 0 | 0 |
| CHOLESTEROL | 0 | 0 | 0 | 0 | 0 | 0 |
| TOTAL CARBOHYDRATE | 17.3 | 17.3 | 17.3 | 17.3 | 17.3 | 19.3 |
| DIETARY FIBER | 0 | 0 | 0 | 0 | 0 | 0.7 |
| SUGARS | 12.4 | 12.4 | 12.4 | 12.4 | 12.4 | 13.7 |
| PROTEIN | 6.3 | 6.3 | 6.3 | 6.3 | 6.3 | 6.3 |

TABLE 9
PRODUCT COMPOSITION COMPARISONS

| | | | | | | | SOYMILK |
|---|---|---|---|---|---|---|---|
| NUTRIENTS | UNITS | EXAMPLE 1 | EXAMPLE 2 | EXAMPLE 3 | EXAMPLE 4 | EXAMPLE 5 | POWDER |
| PROTEIN, DRY BASIS | % | 60.20% | 58.10% | 62.40% | 59.40% | 58.80% | 50.44% |
| FAT | % | 3.20% | 3.50% | 7.40% | 7.40% | 11.40% | 14.55% |
| MOISTURE | % | 0.00% | 0.00% | 0.00% | 0.00% | 0.00% | 3.00% |

The soymilk products produced from reduced-fat extracts of Examples 1 and 2 are no-fat soymilk, and the soymilk products produced from Examples 3, 4, and 5 are low-fat soymilk. The soymilk produced from the commercially available soymilk powder does not meet the standards of either low-fat or no-fat soymilk.

### EXAMPLE 10

### Comparison of the Levels of Soy Sterols Present in Soy Protein Isolates Produced by the Fat Separation Process Compared to Commercially Available Soy Protein Isolates.

Campestrol, stigmasterol and beta-sitosterol content in the soy protein materials was measured as described in the Official Methods of Analysis of AOAC International (2000) 17^{th} Ed. Gaithersburg, Md., USA, Official Method 994.10.(Modified), which is incorporated herein by reference in its entirety. Briefly, the sample was saponified using ethanolic potassium hydroxide. The unsaponifiable fraction containing cholesterol and other sterols was extracted with toluene. The toluene was evaporated to dryness and the residue was dissolved in dimethylformamide (DMF). The samples were derivatized to form trimethylsilyl ethers. The derivatized cholesterol was quantitatively determined by gas chromatography using 5 α-cholestane as an internal standard.

In Table 10, the soy isolates produced in Examples 1-5 are compared with commercially available soy isolates. The total sterol composition of soy isolates produced from full fat soy flour was six times higher than isolates produced from hexane extracted soy flour. Additionally, soy isolates produced from full fat soy flour contain levels of total sterols that are two times higher than isolates produced from extruder press and HPLE soy flours.

TABLE 10
STEROL COMPOSITION

| | | | | | Beta | TOTAL |
|---|---|---|---|---|---|---|
| SOY | | | Campesterol | Stigmasterol | Sitosterol | STEROLS |
| ISOLATES | Manufacturer | Raw Material | mg/100 grams | mg/100 grams | mg/100 grams | mg/100 grams |
| Example 1 | | Extruder Press | 5.4 | 5.7 | 12.6 | 23.7 |
| | | Flour | | | | |
| Example 2 | | HPLE Flour | 6.9 | 6.7 | 16.2 | 29.8 |
| Example 3 | | Full Fat Flour | 15.3 | 14.8 | 25.8 | 55.9 |
| Example 4 | | Full Fat Flour | 11.0 | 10.9 | 18.0 | 39.9 |
| Example 5 | | Full Fat Flour | 15.4 | 12.1 | 35.4 | 62.9 |
| Soy N-ergy | Oleanergie | Extruder Press | 6.0 | 6.2 | 15.3 | 27.5 |
| 90LH | | Flour | | | | |
| Supro 500E | Solae | Hexane Defatted | 2.1 | 2.1 | 8.0 | 12.2 |
| | | Flour | | | | |
| Supro 710 | Solae | Hexane Defatted | 1.8 | 1.8 | 6.8 | 10.4 |
| | | Flour | | | | |
| Pro-Fam | ADM | Hexane Defatted | 1.2 | 1.3 | 3.6 | 6.1 |
| 974 | | Flour | | | | |
| Prolisse 521 | Cargill | Hexane Defatted | 1.6 | 1.7 | 4.8 | 8.1 |
| | | Flour | | | | |

### EXAMPLE 11

### Comparison of the Soy Isolates Produced in Examples 1 Through 3 with Commercially Available Organically Certified Soy Isolates for Gel Strength.

Protein:water gel strength is a measure of the strength of a refrigerated gel of a soy protein. Protein:water gels were prepared by mixing a sample of soy protein material and ice water having a 1:5 protein:water ratio by weight based on a previous protein analysis using the Kjeldahl protein analysis as described in AOAC 18th Ed. Method 991.2.2 which is incorporated herein by reference in its entirety. The protein and ice water slurry was mixed in a Combimax 600 food processor (Braun, Boston, Mass.) for a period of time sufficient to permit the formation of a shiny and smooth gel. The gel was then placed in glass jars (Kerr Inc., Muncie, Ind.) so that no air remained. The jars were sealed with a metallic lid. The jars containing the soy gels were refrigerated for a period 30 minutes at a temperature of between −5° C. and 5° C., and then placed in a water bath at a temperature between 75° C. and 85° C. for 40 minutes. Finally, the gels were chilled to between −5° C. and 5° C. for a period of 12-15 hours. After the refrigeration period, the jars were opened and the gels separated from the jars leaving the gel as one piece. The strength of the gel was measured with a TX-TI texture analyzer (Stable Micro System, Godalming, UK) which drives a cylindrical probe (34 mm long by 13 mm diameter) into the gel until the gel is ruptured by the probe. The gel strength was calculated in newtons from the recorded break point of the gel.

Two commercial organic soy protein products produced from soy flour that has not been extracted with hexane were obtained from Nutriant (Kerry Company, Cedar Falls, Iowa) and Oleanergie (Canada) and were analyzed together with three isolated soy protein products produced from different raw materials (Expeller pressed soy flour, High Pressure Liquid Extraction (HPLE) soy flour, and Full Fat soy flour) in Examples 1-3. The results are shown in Table 11.

TABLE 11
PROTEIN:WATER GEL STRENGTH

| | Gel Strength | Gel Strength |
|---|---|---|
| Soy Isolate Product | (newtons) | (grams) |
| ISO VIII QD Organic (Nutrient) | 0.91 | 93.2 |
| Soy N-ergy ISP 90 (Oleanergie) | 1.97 | 201.3 |
| Example 1 (extruder press flour) | 2.02 | 205.7 |
| Example 2 (HPLE defatted flour) | 2.42 | 246.7 |
| Example 3 (Full Fat Flour) | 2.50 | 255.2 |

As demonstrated in Table 11, all of the products produced using the fat separation process described herein were found to have higher gel strength than that of the commercial organic soy protein products tested, regardless of the raw material used. The gel strength of proteins produced from HPLE soy flour was similar to the gel strength of proteins produced from full fat soy flour, and both were greater than the proteins produced from extruder press flour and commercially available organically certified soy proteins. The gel structures of all the products from Examples 1-3 were firm, shiny and very elastic.

### EXAMPLE 12

### Comparison of the Protein:Oil:Water Emulsion Strength of Soy Protein Compositions

Protein:oil:water emulsion strength is a measure of the strength of a refrigerated oil and water emulsion with soy protein. Protein:oil:water emulsions were prepared by mixing a sample of soy protein material, soybean oil (Wesson Vegetable Oil), and ice water having a 1:5:6 protein:oil:water ratio by weight based on a previous protein analysis using the Kjeldahl protein analysis Method (AOAC 18th Ed. Method 991.2.2). The protein, oil and ice water slurry was mixed in a Combimax 600 food processor (Braun, Boston, Mass.) for a period of time sufficient to permit the formation of a smooth emulsion. The emulsion was then placed in glass jars (Kerr Inc., Muncie, Ind.) so that no air remained. The jars were sealed with a metallic lid. The jars containing the soy emulsions were refrigerated for a period 30 minutes at a temperature of between −5° C. and 5° C. The emulsions were then cooked by placing the jars in a water bath at a temperature between 75° C. and 85° C. for 40 minutes. Finally, the emulsions were chilled to between −5° C. and 5° C. for a period of 12-15 hours. After the refrigeration period, the jars were opened and the emulsions separated from the jars leaving the emulsions as one piece. The strength of the emulsion was measured with a TX-TI texture analyzer (Stable Micro System, Godalming, UK) which drives a cylindrical probe (34 mm long by 13 mm diameter) into the emulsion until it is ruptured by the probe. The emulsion strength was calculated in newtons from the recorded break point of the emulsion.

Oil emulsions were made from the soy protein compositions of Examples 1-3, and analyzed using the above described method. Additionally, two commercially available organic soy protein products from Nutriant (Kerry Company, Cedar Falls, Iowa) and Oleanergie (Canada) were also tested. The isolated soy proteins produced in Examples 1-3 were produced using different raw materials (expeller pressed soy flour, high pressure liquid extraction (HPLE) soy flour, and full fat soy flour). The results are shown in Table 12.

TABLE 12
OIL EMULSION STRENGTH

| | Oil emulsion | Oil emulsion |
|---|---|---|
| Product | (newtons) | (grams) |
| ISO VIII QD Organic (Nutrient) | 0.68 | 69.4 |
| Soy N-ergy ISP 90 (Oleanergie) | 0.88 | 89.9 |
| Example 1 (Extruder Pressed flour) | 0.90 | 92.3 |
| Example 2 (HPLE flour) | 1.34 | 137.14 |
| Example 3 (Full-Fat flour) | 1.43 | 145.8 |

As shown in Table 12, all of the products produced using the fat separation process as described herein were found to have higher emulsion strength than that of the other commercially available organic soy protein products tested. In particular, the proteins produced from full fat and HPLE soy flour in Examples 2 and 3 demonstrate approximately a 35% improvement in oil emulsion strength compared to the commercial organic soy protein products. No fat separated from any of the emulsions and the firmness of the emulsions was sufficient to provide the required structure to a meat emulsion.

### EXAMPLE 13 (PROPHETIC)

### Whole Muscle Meat Injection Using the Soy Protein Compositions.

Meat brines (125% and 150%) may be prepared using each soy protein composition produced by Examples 1 through 6 in order to increase juiciness and yield of a lean ham or whole muscle meat product by injection. The brines are prepared by completely dispersing the protein in the ice water before adding other ingredients. The brines have the following compositions:

% In Brine

| | 125% | 150% |
|---|---|---|
| Ice Water % | 82.0 | 88.0 |
| Salt % | 9.0 | 4.5 |
| STTP % | 3.0 | 1.5 |
| Caregeenan % | 0.0 | 1.5 |
| Protein % | 6.0 | 4.5 |

The injection process is carried out using a Fomaco Injector model FGM 20/40 in two passes (25 psi injection pressure for the first pass and 20 psi for the second). The brine temperature is maintained at 4-6° C. The injected meat pieces are then tumbled in a DVTS-200 Vacuum Tumbler Machine (MPBS industries) for 12 hours with the remainder of the brine. The tumbled pieces are stuffed into 185 mm diameter casings and cooked for 2 hours and 30 minutes at 80° C. A 10° C. water shower is used for final cooling.

All of the resulting injected meat pieces will have a firm bite and dry surface with no visible strips or pockets of the injected brine. These meat pieces will have the following composition.

% In Final
Meat

| | 125% | 150% |
|---|---|---|
| Water % | 13.7 | 29.4 |
| Salt % | 1.5 | 1.5 |
| STTP % | 0.5 | 0.5 |
| Caregeenan % | 0 | 0.5 |
| Meat | 83.3 | 66.6 |
| Protein % | 1 | 1.5 |

### EXAMPLE 14 (PROPHETIC)

### Meat Emulsion Preparation Using the Soy Protein Compositions.

Meat emulsions may be formulated according to the following recipe and ingredients using the soy protein compositions of Examples 1, 2, 3 and 6.

| INGREDIENT | % IN FORMULA |
|---|---|
| Mechanically Deboned Meat (MDM) | 42.00 |
| PORK FAT | 9.00 |
| ICE/WATER | 32.28 |
| MODIFIED CORN STARCH | 3.00 |
| SOY PROTEIN | 5.50 |
| SEASONING | 5.00 |
| PHOSPHATE | 0.40 |
| CURE SALT | 0.32 |
| SODIUM LACTATE | 2.50 |
| TOTAL: | 100.00 |

The cure salt, phosphate, soy protein, MDM and half of the water are placed into a Hobart cutter and chopped until the protein is fully hydrated, followed by the addition of the remaining ingredients. The final emulsion is chopped until the emulsion reaches a temperature of 13° C., then sealed in a vacuum bag followed by hand stuffing a 70 mm impervious casing (liver sausage type) by cutting the vacuum bag end. The stuffed casings are held in ice water 30 minutes, and then cooked in an 80° C. water kettle until the internal temperature of the emulsion reaches 74° C. The cooked meat emulsion is then cooled in ice water.

Cooked meat emulsions prepared from the products of these Examples will exhibit a firm bite and dry surface with no visible fat separation.

### EXAMPLE 15 (PROPHETIC)

### Extended Meat Patties Prepared Using the Soy Protein Compositions.

Meat patties extended with soy protein may be prepared by adding one part of the unique soy protein compositions produced in Examples 1, 2, 3 and 6 to be chopped with 2.5 parts of water at 70° C. in a food cutter (Hobart model 84145, Troy, Ohio) at slow speed for 20-30 seconds, followed by high speed cutting for 2 to 3 minutes, to produce wet gels. The wet gels are refrigerated overnight at 4-6° C. The gels are removed from refrigeration, and chopped for 10-20 seconds in the Hobart cutter to produce individual and distinct protein granules of approximately 30 mm size.

The granules produced as described above are then used to prepare hexane-free low fat burgers using the formula below. The ground beef is chopped in the Hobart cutter with the addition of water and granules for 2-3 minutes. The remaining ingredients are added to a mixer and blended for an additional 1 minute. The entire mixture is grounded in a meat grinder through a ⅛″ plate and formed into burgers using a former (Formax Inc. model F-6, Mokena, Ill.). The formed burgers are then frozen in a blast freezer at −40° C.

| Ingredients | % |
|---|---|
| Ground beef | 77.9 |
| Protein granules | 13 |
| Water | 5 |
| Caregeenan | 0.5 |
| Starch | 2.5 |
| Salt | 0.7 |
| Seasoning | 0.4 |

### EXAMPLE 16 (PROPHETIC)

### Meat Analog Patties are Prepared Using the Soy Protein Compositions.

Protein granules are produced from soy proteins produced in Examples 1, 2, 3, and 6 as described in Example 15, and are used to prepare organic certified meat analog patties using the following formulation:

| Ingredients | % |
|---|---|
| Soy protein composition | 4.0 |
| Hexane free Protein granules | 15 |
| Wheat Gluten 75 (Fielders Starches, Port Melbourne, Australia) | 7 |
| Organic Soybean oil (Sunrich food group, Hope, MN) | 15 |
| Methyl cellulose, (Methocel A4M, Dow Chemical Company, | 1.5 |
| Midland, MI) | |
| Organic cane sugar | 0.3 |
| Organic TVP (Nutriant) | 18 |
| Organic Soy Okara (Sunrich food group, Hope, MN) | 3 |
| Water | 34.2 |
| Sodium carbonate | 0.4 |
| Salt | 1.2 |
| Seasoning (Ogawa Beef Flavor #B18538, 2.8 Ogawa, | 0.4 |
| Tokyo, Japan) | |

The organic TVP is mixed with 10% of the water and the sodium carbonate in a food cutter (Hobart Manufacturing Co., model 84145, Troy, Ohio) for two minutes. The protein granules are added to the mixture and mixed one minute and the mixture is then refrigerated at 4-6° C. The remaining water is heated to 80° C. and chopped on high speed with the methylcellulose for one minute in the same Hobart cutter. The soy protein composition is added to the cutter and chopped on high speed for 2 minutes. The soybean oil is added slowly with high speed chopping and chopped one minute. The remaining ingredients are added and chopped 3 minutes. The refrigerated TVP, granules, and sodium carbonate mixture is then added to the emulsion and mixed two minutes. The mixture is formed into patties using a Formax F-6 former (Formax Inc., Mokena, Ill.). Patties are flash frozen at −40° C.

### EXAMPLE 17 (PROPHETIC)

### Soy-Based Yogurt Analog Prepared Using the Soy Protein Compositions.

Soy-based yogurt analogs may be prepared from the soy protein compositions identified in Examples 1-6. The ingredients and formula are as follows.

| Ingredients | % |
|---|---|
| Sweet Dairy Whey | 34.5 |
| Soy Protein Product | 33.5 |
| Vegetable Oil | 26.2 |
| Sugar | 3.0 |
| Emulsifiers | 1.5 |
| Vitamins, Minerals | 1.0 |
| Flavoring | 0.5 |

All oils for the tests are combined in a tank and heated to 70° C., and the emulsifiers are added. The soy protein composition is dispersed in a separate tank with water at 49° C. at 18% solids. The whey and sugars are then added and blended for 15 minutes prior to the addition of the oil with emulsifiers. The solution is then heated to 90° C. for 5 minutes, homogenized in a two stage homogenizer at 2500 and 500 psi respectively, then cooled to 35° C. After the entire mixture reaches 35° C., a 2% standard yogurt starter culture is inoculated. The temperature is maintained at 35° C. until the pH of the mixture reaches 4.6, then the vitamins, minerals, and flavorings are added, and the mixture is cooled to 4° C. for packaging.

### EXAMPLE 18 (PROPHETIC)

### Frozen Desert Prepared Using the Soy Protein Compositions.

This example illustrates how a frozen desert can be made using the soy protein compositions of Examples 1-6. The ingredients and formula are identified below:

| INGREDIENT | % |
|---|---|
| Water | 61.25 |
| Hydrogenated Soybean Oil | 10.00 |
| Soy Protein Composition | 8.00 |
| Corn Syrup Solids 42 Dextrose Equivalent | 8.00 |
| Sucrose | 12.00 |
| Stabilizer Blend | 0.75 |

Stabilizer Blend formula:
Cellulose Gum 72.45%
Carboxymethyl Cellulose 8.70%
Locust Bean Gum 7.25%
Xanthan Gum 5.80%
Caregeenan 2.90%

The soy protein composition is added to the water under sufficient agitation at 54° C. until fully hydrated. All other dry ingredients are added to the water under sufficient agitation for complete mixing. The hydrogenated soybean oil is added under the same agitation until thoroughly mixed. The solution is pasteurized at 78° C. for 20 seconds and homogenized at 100/33 bar. The mixture is frozen with 70 to 100% overrun and is then packaged to harden.

### EXAMPLE 19 (PROPHETIC)

### Preparation of a Soy-Based Milk Replacer.

A soy-based whole milk replacer can be made using the soy protein compositions of Examples 1-6. The ingredients used in the formulation and the procedure are described below.

| Ingredients | % |
|---|---|
| Sweet Dairy Whey | 40 |
| Soy Protein composition | 24 |
| Vegetable oil | 24 |
| Gelatin | 3 |
| Sucrose | 6 |
| Emulsifier | 1.5 |
| Salts and Vitamins | 1 |
| Mineral and Flavoring | 0.5 |

The vegetable oil is heated to 66° C. and then the emulsifier is added. In a separate tank, the soy protein product is stirred into water at 49° C. with adequate agitation at 18% solids. Neutrase enzyme (or other suitable protease) is added at 0.1% of protein weight under constant agitation for one hour to hydrolyze the protein in the soy solution. The solution is pasteurized after an hour to stop the reaction by denaturing the enzyme. The whey, sugar, gelatin, salts, minerals, and flavors are added and blended for 15 minutes before the oil and emulsifier are added. After the entire mixture is blended for an additional 15 minutes, it is homogenized, pasteurized, and spray dried. The soy-based milk replacer performs well and retains the ability to emulsify fat and remain soluble after rehydration.

### EXAMPLE 20 (PROPHETIC)

### Infant Formula Prepared Using the Soy Protein Compositions.

This example illustrates making a soy-based infant formula using the soy protein compositions of Examples 1-6. The ingredients used in the formulation and the procedure are as follows:

| Ingredients | % |
|---|---|
| Protein compositions | 15 |
| 42 Dextrose Equivalent Corn Syrup solids | 35 |
| Sucrose | 21 |
| Vitamins & Mineral | 3 |
| Corn Oil | 14 |
| Coconut Oil | 10.6 |
| Emulsifier | 1.4 |

The vegetable oils are heated to 66° C. then the emulsifier is added. In a separate tank, the soy product is stirred into water at 49° C. with adequate agitation to 18% solids. Neutrase enzyme (or other suitable protease) is added at 0.1% of protein weight under constant agitation for one hour to hydrolyze the protein in the soy solution. The solution is pasteurized after an hour to stop the reaction by denaturing the enzyme. All other ingredients are added and blended for 15 minutes before the oil with emulsifier is added. After the entire mixture is blended for an additional 15 minutes, it is homogenized, pasteurized and spray dried. The soy based infant formula performs well in the ability to emulsify fat and remain soluble after rehydration

### EXAMPLE 21 (PROPHETIC)

### Ready to Drink and Powdered Beverages.

A high protein, ready to drink beverage may be formed using the soy protein compositions from Examples 1-6. The ingredients used in the formulations are below.

### Ready to Drink:

| Ingredients | % |
|---|---|
| Water | 78.6 |
| Soy protein composition | 9.5 |
| Sucrose | 10.0 |
| Cocoa | 0.45 |
| Vitamins/Minerals | 0.5 |
| Flavor | 0.5 |
| Cellulose gel | 0.45 |

The soy protein composition is added to the water at 60° C. under strong agitation until fully hydrated. The cocoa is pre-blended with the cellulose gel and the sugar, then added to the protein water mixture and the final vitamins, minerals, and flavors are added. The mixture is homogenized, pasteurized, and packaged in aseptic or retort containers. One 240 ml serving of the high protein, ready to drink beverage will supply 20 grams of protein per serving.

### Powdered Beverage:

| Ingredients | % |
|---|---|
| Soy protein compositions | 59 |
| Sucrose | 13 |
| Maltodextrin | 27 |
| Vitamins/Minerals | 0.5 |
| Aspartame | 0.2 |
| Flavor | 0.3 |

All ingredients are added to a ribbon or other dry powder blender until all of the powdered ingredients are well mixed, then packaged. Thirty grams of the powdered beverage formulation may be added to 8 ounces of water or juice to form a serving containing about 15 grams of soy protein.

### EXAMPLE 22 (PROPHETIC)

### Food Bars Prepared Using the Soy Protein Compositions.

A food bar may be formed using the protein compositions described herein using the following components:

| Ingredients | % |
|---|---|
| Soy protein composition | 25 |
| Corn syrup | 40 |
| Rice syrup solids | 10 |
| Glycerin | 3 |
| Cocoa | 5 |
| Compound coating | 17 |

The soy protein composition from one of Examples 1-6 is added to corn syrup at 160° C. in a high shear mixer until fully blended. The glycerin and rice syrup are added until the mixture is fully mixed. The temperature is increased to 95° C. in a scraped surface heat exchanger and held for 5 minutes, then fed to a extruder/former to shape a continuous bar with width of 40 mm and a height of 20 mm. The continuous rectangular bar is cut into lengths of 100 mm in a continuous process creating a food bar with 60 grams weight. Separately, the cocoa is added to the coating compound and heated to 70° C. The coating compound mixture is pumped onto the moving continuous bar such that 10 grams of coating is applied to each 60 gram bar. The 70 gram bar is cooled to 25° C. by blowing conditioned air onto the moving product, and the food bar is packaged in a metallic coated flexible packaging as a hexane free protein rich nutritional bar containing 15 grams of protein per bar.

### EXAMPLE 23 (PROPHETIC)

### Imitation Processed Cheese Spread Prepared Using the Soy Protein Compositions.

The soy protein compositions of Examples 1-6 may be used to prepare a soy-extended, reduced cost imitation processed cheese spread. The ingredients, formulations, and procedure used in the preparation of the imitation processed cheese spread are provided below.

| Formula | % |
|---|---|
| Soy Protein compositions | 4.0 |
| Rennet Casein | 12.75 |
| Vegetable Oil | 23.0 |
| Sodium Citrate | 0.5 |
| Disodium Phosphate | 1.0 |
| Sodium Aluminum Phosphate | 0.50 |
| Whey Powder | 1.25 |
| Lactic Acid | 0.50 |
| Water | 56.5 |

The Rennet casein, soy protein composition, and whey are dry blended together thoroughly. The oil is added to a processed cheese cooker at 66° C. with disodium phosphate, sodium citrate, sodium aluminum phosphate, and flavor. Water is added to the oils and salt at 66° C. and the dry blend is added slowly. Lactic acid is added slowly and the mixture is heated to 85° C. for 30-60 seconds. The imitation processed cheese spread is then packaged and cooled. The imitation processed cheese is firm, white, and has typical imitation cheese flavor properties.

### EXAMPLE 24 (PROPHETIC)

### Protein-Enriched Bread Prepared Using the Soy Protein Compositions.

The soy protein compositions of Examples 1-6 may be used to prepare protein-enriched soy-based bread. The formula for a soy protein-enriched bread is as follows:

| Formula | % |
|---|---|
| Sponge | |
| Flour | 65 |
| Water | 37 |
| Yeast | 2.5 |
| Yeast food | 0.5 |
| Dough | |
| Soy protein | 10 |
| Flour | 29 |
| Sugars | 8 |
| Salts | 2 |
| Shortening | 3 |
| Nonfat dry milk solids | 6 |
| Water | 41.5 |
| Emulsifier | 0.5 |

The sponge ingredients are mixed together for 5 minutes. The yeast and yeast food are dissolved first with part of the sponge water and added as liquids. The sponge is fermented for 5 hours at 86° F. and 75% R.H. The fermented sponge is then added to a dry mixture of all the other ingredients. The dough is mixed for 15 minutes and then fermented for 20 minutes at 86° F. and 75% RH. After fermentation the dough is divided into 15 ounce rounded pieces and placed into bread pans. The dough is then proofed at 100° F. and 85% R.H for 69 minutes then baked at 425° F. for 20 minutes to produce a protein rich bread.

### EXAMPLE 25 (PROPHETIC)

### Breakfast Cereal Prepared Using the Soy Protein Compositions.

The soy protein compositions of Examples 1-6 may also be used to prepare protein-enriched soy-based breakfast cereals. The soy protein-enriched breakfast cereal is prepared according to the following formula.

| Formula | % |
|---|---|
| Soy protein composition | 22.5 |
| Brewer's grits (Corn) | 70 |
| Sucrose | 5.5 |
| Salt | 2 |

The brewer's grits, sucrose protein and salt are blended with water to make a 40% moisture mixture. This mixture is then fed into an extruder under pressure of 600 PSI and 180° F. and fed into stands having circular cross section of 3/16 inch. After 20 minutes at room temperature the strands are sliced into pellets that then passed a 2 roll mill to produce flakes of about 0.01 inch thickness. These flakes are then dried to a moisture content of 10% and packaged.

### EXAMPLE 26

### Preparation of a Coffee Creamer Formulation from the Soy Cream Fraction of the Fat Separation Process.

A coffee creamer powder was produced using the soy cream fraction of the fat separation process as described herein. The soy cream fraction contained 48.6% dry solids and 96% dry basis acid hydrolyzed fat. Two point twenty five grams of the soy cream fraction were premixed under vigorous agitation with 120 grams of mono- and di-glycerides (Danisco USA, New Century, Kans.) to obtain emulsified and homogenous slurry. In a separate tank 1.01 kilogram of second acid curd containing 22% dry solids prepared from the fat separation process (240 grams solids) were mixed with 1 kilogram of water and the pH was neutralized to pH 6.5 using a 15% sodium hydroxide solution. The cream and mono-di-glycerides mixture was then gradually poured into the neutralized acid curd slurry and mixed together while heating to 140° F. to produce a shiny emulsion solution. 180 grams of pure cane sugars (wholesome sweeteners, Sugar Land, Tex.) were then added to the mixture together with 5.322 kilogram of rice syrup (79 brix, Corigins Inc., Laconia, N.H.). The slurry was then heated to 170° F. and 240 grams of 50% Dipotassium phosphate solution together with 3 grams of natural sweet cream flavor (Chris Hansen, Mahwah. NJ) were added to the mixture. The final mixture was held for 10 minutes at 170° F., and then homogenized in a two stage homogenizer (Manton Gaulin) at 2500 and 500 psi, then spray dried as identified in Example 1. The dry powder contained a 3.66% Kjeldahl dry basis protein and 18.68% dry basis acid hydrolyzed fat, and was easily dispersed in filtered coffee.

What is claimed is:

1. A method of processing a soy material, comprising:
a) aqueously extracting the soy material to produce an extract; and
b) centrifugally separating the extract into a fat-enriched fraction and a reduced-fat soy extract.

2. The method of claim 1, wherein the method is continuous or semi-continuous.

3. The method of claim 1, wherein the extraction and separation steps are performed substantially concurrently.

4. The method of claim 1, wherein the aqueous extraction comprises contacting the soy material with an aqueous solution.

5. The method of claim 4, wherein the aqueous solution has an ionic strength of about 0.10 N or less.

6. The method of claim 5, wherein the aqueous solution is substantially free of demulsifiers.

7. The method of claim 5, wherein the extract comprises fat capable of being centrifugally separated from the extract without requiring the addition of demulsifiers.

8. The method of claim 7, wherein the reduced-fat extract has a protein to fat ratio of at least about 4 to 1.

9. The method of claim 1, wherein the extract has a pH in the range of about 6.0 to about 10.5.

10. The method of claim 9, wherein the pH is greater than about 7.0.

11. The method of claim 9, wherein the pH is about 9.0 or less.

12. The method of claim 1, wherein step (a) is performed at a temperature in the range of about 32° F. to about 200° F.

13. The method of claim 12, wherein the temperature is between about 80° F. and about 150° F.

14. The method of claim 12, wherein the temperature is between about 90° F. and about 145° F.

15. The method of claim 1, wherein the soy material is a substantially full fat soy material.

16. The method of claim 1, wherein the soy material is a partially defatted soy material.

17. The method of claim 16, wherein the soy material is partially defatted by a hot press.

18. The method of claim 16, wherein the soy material is partially defatted by a cold press.

19. The method of claim 16, wherein the soy material is partially defatted by high pressure liquid extraction.

20. The method of claim 1, wherein the soy material is milled prior to aqueous extraction.

21. The method of claim 20, wherein the milled soy material comprises a flour.

22. The method of claim 4, wherein the aqueous solution is substantially free of demulsifiers.

23. The method of claim 1, wherein the extract comprises fat capable of being centrifugally separated from water in the aqueous extract without requiring the addition of demulsifiers.

24. The method of claim 23, wherein the reduced-fat extract has a protein to fat ratio of at least about 4 to 1.

25. The method of claim 1, wherein step (b) is performed using a three phase separator.

26. The method of claim 1, wherein the extract comprises an insoluble fiber, further comprising centrifugally separating at least a portion of the insoluble fiber from the extract of step (a) prior to step (b) to form an insoluble fiber fraction.

27. The method of claim 26, wherein step (b) is performed using a three phase separator to produce the fat-enriched fraction, the reduced-fat extract and a protein-fat sediment.

28. The method of claim 1, further comprising processing the fat-enriched fraction to produce a crude oil.

29. The method of claim 28, further comprising processing crude oil to produce soy gums and a degummed oil.

30. The method of claim 29, further comprising processing the degummed oil to produce an oil.

31. The method of claim 1, further comprising drying the reduced-fat extract.

32. The method of claim 31, wherein drying comprises at least one of evaporating or spray drying.

33. The method of claim 1, further comprising fractionating the reduced-fat fraction.

34. The method of claim 33, wherein fractionating the reduced fat extract produces a reduced-fat glycinin-rich fraction.

35. The method of claim 33, wherein fractionating the reduced-fat extract produces a reduced-fat beta-conglycinin-enriched fraction.

36. The method of claim 1, further comprising concentrating the reduced-fat extract and separating the reduced-fat extract to produce a first reduced-fat soy protein composition and an aqueous fraction.

37. The method of claim 36, wherein concentrating and separating comprise:
adding acid to the reduced-fat extract to produce a first curd and a whey; and
separating the first curd from the whey to produce a first reduced-fat soy protein composition.

38. The method of claim 37, further comprising:
washing the first reduced-fat soy protein composition to produce a second reduced-fat soy protein composition.

39. The method of claim 36, wherein concentrating and separating comprise:
filtering the reduced-fat extract to produce a first reduced-fat soy protein composition.

40. The method of claim 39, further comprising:
subjecting the first reduced-fat soy protein composition to ultrafiltration, microfiltration or diafiltration.

41. The method of claim 36, further comprising washing the first reduced-fat soy protein composition to produce a second reduced-fat soy protein composition.

42. A reduced-fat soy extract produced according to the method of claim 1.

43. The reduced-fat soy extract of claim 42, wherein the extract comprises at least about 55% dry weight protein.

44. The reduced-fat soy extract of claim 42, wherein the extract comprises about 15% or less dry weight fat.

45. The reduced-fat soy extract of claim 42, wherein the extract comprises about 10% or less dry weight fat.

46. The reduced-fat soy extract of claim 42, wherein the extract comprises a protein to fat ratio of at least 5 to 1.

47. The reduced-fat soy extract of claim 42, wherein the extract comprises a protein to fat ratio of at least 8 to 1.

48. The reduced-fat soy extract of claim 42, wherein the extract comprises a protein to fat ratio of at least 12 to 1.

49. The reduced-fat soy extract of claim 42, wherein the soy material is a substantially full fat soy material.

50. The reduced-fat soy extract of claim 42, wherein the soy material is a cold pressed soy material.

51. The reduced-fat soy extract of claim 42, wherein the soy material is a high pressure liquid extracted soy material.

52. The reduced-fat soy extract of claim 42, wherein the soy material is a hot pressed soy material.

53. A reduced-fat soy protein composition comprising at least 65% dry weight protein produced according to the method of claim 36.

54. The reduced-fat soy protein composition of claim 53, wherein the composition comprises at least about 85% dry weight protein.

55. The reduced-fat soy protein composition of claim 53, wherein the composition comprises about 15% or less dry weight fat.

56. The reduced-fat soy protein composition of claim 53, wherein the composition comprises about 10% or less dry weight fat.

57. The reduced-fat soy protein composition of claim 53, wherein the composition comprises a protein to fat ratio of at least 5 to 1.

58. The reduced-fat soy protein composition of claim 53, wherein the composition comprises a protein to fat ratio of at least 8 to 1.

59. The reduced-fat soy protein composition of claim 53, wherein the composition comprises a protein to fat ratio of at least 12 to 1.

60. The reduced-fat soy protein composition of claim 53, wherein the soy material is selected from a substantially full fat soy material and a high pressure liquid extracted soy material.

61. The reduced-fat soy protein composition of claim 60, wherein the soy material is a substantially full fat soy material.

62. The reduced-fat soy protein composition of claim 60, wherein the soy material is a high pressure liquid extracted soy material.

63. The reduced-fat soy protein composition of claim 60, the composition having a protein:water gel strength at least about 20% higher than that of a soy protein composition prepared from hot pressed soy material.

64. The reduced-fat soy protein composition of claim 60, the composition comprising at least about 80% dry weight protein and having a protein:water gel strength of at least about 2.2 newtons, as measured by the method of Example 11.

65. The reduced-fat soy protein composition of claim 60, the composition comprising at least about 80% dry weight protein and having a protein:water gel strength of at least about 2.40 newtons, as measured by the method of Example 11.

66. The reduced-fat soy protein composition of claim 60, the composition having an oil emulsion strength at least about 20% higher than that of a soy protein composition prepared from hot pressed soy material.

67. The reduced-fat soy protein composition of claim 60, the composition comprising at least about 80% dry weight protein and having an oil emulsion strength of about 1.1 newtons or higher, as measured by the method of Example 12.

68. The reduced-fat soy protein composition of claim 60, the composition comprising at least about 80% dry weight protein and having an oil emulsion strength of about 1.3 newtons or higher, as measured by the method of Example 12.

69. The reduced-fat soy protein composition of claim 61, the composition having a surface hydrophobicity at least about 15% higher than that of a soy protein composition prepared from hot pressed soy material.

70. The reduced-fat soy protein composition of claim 61, wherein the surface hydrophobicity of the composition is at least about 30% higher than that of a soy protein composition prepared from hot pressed soy material.

71. The reduced-fat soy protein composition of claim 61, the composition comprising at least about 80% dry weight protein and having a surface hydrophobicity slope of at least about 100, as measured by the method of Example 7.

72. The reduced-fat soy protein composition of claim 53, wherein the soy material is a hot pressed soy material.

73. The reduced-fat soy protein composition of claim 53, wherein the soy material is a cold pressed soy material.

74. A fat-enriched fraction produced according to the method of claim 1.

75. The fat-enriched fraction of claim 74, wherein the soy material is a substantially full fat soy material.

76. A crude oil produced according to the method of claim 28.

77. The crude oil of claim 76, wherein the crude oil is prepared from a non-hexane extracted soy material.

78. The crude oil of claim 77, the crude oil having a free fatty acid value of about 1.0 or less as measured by the method of Example 8.

79. The degummed oil produced according to the method of claim 29.

80. The degummed oil of claim 79, wherein the degummed oil is prepared from a non-hexane extracted soy material.

81. The degummed oil of claim 80, the degummed oil having a free fatty acid value of about 1.0 or less as measured by the method of Example 8.

82. Soy gums produced according to the method of claim 29.

83. The soy gums of claim 82, wherein the soy material is a substantially full fat soy material.

84. The protein-fat sediment produced according to the method of claim 27.

85. The reduced-fat glycinin-enriched fraction produced according to the method of claim 34.

86. The reduced-fat beta-coglycinin-enriched fraction produced according to the method of claim 35.

87. A soy protein composition comprising at least about 65% dry weight protein, produced from a non-hexane, non-alcohol treated soy material having a Protein Dispersibility Index of at least about 60%.

88. The composition of claim 87, wherein the composition comprises a fat content of about 15% or less dry weight.

89. The composition of claim 87, wherein the composition comprises a fat content of about 10% or less dry weight.

90. The composition of claim 87, wherein the composition comprises at least 85% dry weight protein.

91. The composition of claim 87, wherein the soy material is selected from a substantially full fat soy material and a high pressure liquid extracted soy material.

92. The composition of claim 91, wherein the soy material is a substantially full fat soy material.

93. The composition of claim 91, wherein the soy material is a high pressure liquid extracted soy material.

94. The composition of claim 91, the composition having a protein:water gel strength at least about 20% higher than that of a soy protein composition prepared from hot pressed soy material.

95. The composition of claim 91, the composition comprising at least about 80% protein and having a protein:water gel strength of at least about 2.2 newtons, as measured by the method of Example 11.

96. The composition of claim 91, the composition having an oil emulsion strength at least about 20% higher than that of a soy protein composition prepared from hot pressed soy material.

97. The reduced-fat soy protein composition of claim 91, the composition comprising at least about 80% dry weight protein and having an oil emulsion strength of about 1.1 newtons or higher, as measured by the method of Example 12.

98. The reduced-fat soy protein composition of claim 92, the composition having a surface hydrophobicity at least about 15% higher than that of a soy protein composition prepared from hot pressed soy material.

99. The reduced-fat soy protein composition of claim 92, the composition having a surface hydrophobicity at least about 30% higher than that of a soy protein composition prepared from hot pressed soy material.

100. The reduced-fat soy protein composition of claim 92, the composition comprising at least about 80% dry weight protein and a having surface hydrophobicity slope of about 100 or higher as measured by the method of Example 7.

101. The composition of claim 87, wherein the soy material is a hot pressed soy material.

102. The composition of claim 87, wherein the soy material is a cold pressed soy material.

103. The composition of claim 87, wherein the composition comprises about 7% or less dry weight fat.

104. The composition of claim 87, wherein the Protein Dispersibility Index is at least about 80%.

105. The composition of claim 87, wherein the composition comprises a protein to fat ratio of at least 5 to 1.

106. The composition of claim 87, wherein the protein to fat ratio is at least about 8 to 1.

107. A food product containing the soy protein composition of claim 87.

108. The food product of claim 107, wherein the food product is a confectionary product, a bakery product, an emulsified meat product, a ground meat product, an injection meat product, a meat analog product, a cereal, a bar, a dairy analog product, a beverage, a soymilk, a liquid or powdered dietetic formula, a texturized soy product, a pasta, a health nutrition supplement, or a nutrition bar.

109. The food product of claim 107, wherein the confectionary product is a candy or chocolate.

110. The food product of claim 107, wherein the bakery product is a bread, a roll, a biscuit, a cake, a yeast baked good, a cookie, a pastry, or a snack cake.

111. The food product of claim 107, wherein the injection meat product is a ham, a poultry product, a pork product, a seafood product or a beef product.

112. The food product of claim 107, wherein the emulsified meat product is a sausage, a bratwurst, a salami, a bologna, a lunchmeat, or a hot dog.

113. The food product of claim 107, wherein the ground meat product is a fish stick, a meat patty, a meatball, a ground seafood product, a ground pork product, a ground poultry product or a ground beef product.

114. The food product of claim 107, wherein the meat analog product is a meat patty, sausage, hot dog, lunchmeat, or ground crumble.

115. The food product of claim 107, wherein the dairy analog product is a milk product, a yogurt, a sour cream, a whipped topping, a ice cream, a cheese, a shake, a coffee whitener or a cream product.

116. The food product of claim 107, wherein the dietetic formula is an infant formula, a geriatric formula, a weight loss preparation, a weight gain preparation, a sports drink, or a diabetes management preparation.

117. A food product prepared from a soy protein composition comprising at least 65% dry weight protein prepared from a non-hexane, non-alcohol treated soy material having a PDI greater than 60%.

118. The food product of claim 117, wherein the soy material is a substantially full fat soy material.

119. The food product of claim 117, wherein the soy protein composition has a substantially bland taste.

120. The food product of claim 117, wherein the soy protein composition comprises at least 85% dry weight protein.

121. A soy extract comprising at least about 55% dry weight protein, the extract produced by non-hexane, non-alcohol extraction of a soy material, the soy material having a Protein Dispersibility Index of at least about 70%.

122. The extract of claim 121, wherein the soy material is a substantially full fat soy material.

123. The extract of claim 121, wherein the extract comprises a fat content of about 15% or less dry weight.

124. The extract of claim 121, wherein the extract comprises about 10% or less dry weight fat.

125. The extract of claim 121, wherein the Protein Dispersibility Index is at least about 75%.

126. The extract of claim 121, wherein the extract comprises a protein to fat ratio of at least 5 to 1.

127. The extract of claim 121, wherein the extract comprises at least about 6.25 g protein per 8 fluid ounces and less than or equal to about 1.0 g fat per 8 fluid ounces.

128. The extract of claim 121, wherein the protein to fat ratio is at least about 8 to 1.

129. The extract of claim 121, wherein the extract comprises no more than 0.5 g fat per 8 fluid ounces.

130. A food product containing the soy extract of claim 121.

131. The food product of claim 130, wherein the food product is a confectionary product, a bakery product, an emulsified meat product, a ground meat product, an injection meat product, a meat analog product, a cereal, a bar, a dairy analog product, a beverage, a soymilk, a liquid or powdered dietetic formula, a texturized soy product, a pasta, a health nutrition supplement, or a nutrition bar.
